(19) United States
(12) Patent Application Publication
(10) Pub. No.: US 2026/0289136 A1
(43) Pub. Date: Sep. 24, 2026

(54) SYSTEM

(71) Applicant: SoftBank Group Corp., Tokyo (JP)

(72) Inventor: Hiroki YOSHIZAWA, Tokyo (JP)

(73) Assignee: SoftBank Group Corp., Tokyo (JP)

(21) Appl. No.: 19/564,324

(22) Filed: Mar. 12, 2026

(30) Foreign Application Priority Data
Mar. 19, 2025 (JP) 2025-045050

(51) Int. Cl. G06F 40/30; G06F 16/3329; G06F 40/247; G06F 40/284

(52) U.S. Cl. CPC G06F 40/30; G06F 16/33295; G06F 40/247; G06F 40/284

(57) ABSTRACT

A system includes a processor that is configured to extract vocabulary from planning and design documents and business communications by using a natural language processing technique, analyze semantic relationships among the extracted vocabulary to generate a common language set that maintains consistency and accuracy, and create a prompt sentence for instructing a generative AI model to execute a specific task by using the generated common language set.

### CROSS-REFERENCE TO RELATED APPLICATION

This application is based on and claims priority under 35 USC 119 from Japanese Patent Application No. 2025-045050 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional software development and business communication environments often suffer from inconsistent terminology across planning and design documents, business communications, and interactions with generative AI models. Different stakeholders, such as planners, designers, engineers, and business users, may use different words or phrases to refer to the same concept, which causes ambiguity, misinterpretation, and inefficiency. Furthermore, when generative AI models are introduced into such environments, prompts are frequently created in an ad hoc manner without a systematically defined common language set. As a result, the behavior of the generative AI model may become unstable, and the reproducibility, reliability, and accuracy of AI-generated outputs are degraded. In addition, conventional systems do not sufficiently take into account a user's emotional state when managing or adjusting the terminology used to interact with generative AI models, which can lead to outputs that are perceived as inappropriate, insensitive, or misaligned with the user's current situation. Moreover, there is a lack of integrated mechanisms that automatically feed back the responses and proposals from generative AI models into the terminology management process in order to continuously refine the prompt design and the underlying language resources. Therefore, there is a need for a system that can automatically extract vocabulary from planning and design documents and business communications, generate and maintain a consistent and accurate common language set, dynamically create and refine prompts for generative AI models based on that common language set, and further adjust such a common language set in consideration of the user's emotions and the AI model's responses.

### SUMMARY

To solve the above-described problems, a system according to at least one embodiment comprises a processor configured to execute a series of operations. The processor is configured to extract vocabulary from planning and design documents and business communications by using a natural language processing technique, such as tokenization, part-of-speech tagging, term extraction, and importance scoring, and to collect domain-relevant terms that appear in project artifacts and communications. The processor is further configured to analyze semantic relationships among the extracted vocabulary, for example by computing similarity measures based on semantic embeddings or other language models, and to generate a common language set that maintains consistency and accuracy by grouping semantically related terms and selecting canonical terms for each group. In addition, the processor is configured to create, by using the generated common language set, a prompt sentence for instructing a generative AI model to execute a specific task, such that the prompt reflects standardized terminology and reduces ambiguity in AI interactions. In some embodiments, the processor is configured to analyze a user's text input or voice input to recognize an emotion of the user by applying an emotion recognition model, and to adjust the common language set based on the recognized emotion, for example by selecting emotionally appropriate terms or modifying the style of prompts. In further embodiments, the processor is configured to input the prompt sentence to the generative AI model, obtain a response or a proposal from the generative AI model, and use the obtained response or proposal to further refine the common language set and subsequent prompt generation, thereby enabling an adaptive and feedback-driven system that maintains consistent terminology, improves communication quality, and enhances the performance and usability of generative AI in development and business processes.

The term “processor” refers to a hardware or software processing unit, such as a CPU, GPU, microcontroller, or a combination of such components, that executes instructions to perform the functions defined in the system, including vocabulary extraction, semantic analysis, prompt generation, emotion recognition, and interaction with a generative AI model. The term “planning and design documents” refers to documents created in the course of planning, designing, or specifying a system, product, or service, including but not limited to requirement specifications, design specifications, architecture documents, and project planning materials.

The term “business communications” refers to textual or voice-based exchanges occurring in a business or organizational context, including but not limited to emails, chat messages, meeting transcripts, support tickets, and internal reports.

The term “natural language processing technique” refers to any computational method or algorithm configured to process and analyze human language, including but not limited to tokenization, morphological analysis, part-of-speech tagging, syntactic parsing, semantic analysis, term extraction, and embedding-based representation.

The term “vocabulary” refers to a set of words, phrases, or terms extracted from planning and design documents or business communications that represent concepts, entities, actions, or attributes relevant to a particular domain or project.

The term “semantic relationships” refers to relationships between words, phrases, or terms based on their meanings, including but not limited to synonymy, hypernymy, hyponymy, and other forms of conceptual similarity or relatedness as determined by linguistic or statistical analysis.

The term “common language set” refers to a structured collection of terms and their relationships that is designed to provide consistent and accurate terminology for a particular domain or project, and that may include canonical terms, associated synonyms, definitions, and usage examples.

The term “consistency and accuracy” refers to the property of the common language set in which the same concept is expressed using the same canonical term across different documents and interactions, and in which the definitions and usages of terms correctly reflect the intended domain meaning.

The term “prompt sentence” refers to a text string or sequence of tokens that is constructed for input to a generative AI model in order to instruct the generative AI model to perform a specific task, such as generating content, providing an answer, or making a proposal.

The term “generative AI model” refers to an artificial intelligence model that is configured to generate text or other content in response to an input prompt, including but not limited to large language models and other machine learning models capable of producing natural language outputs.

The term “specific task” refers to a task designated by the system or user for execution by the generative AI model, including but not limited to answering a question, drafting a document, summarizing content, proposing design options, or generating code.

The term “user's text input” refers to a sequence of characters, words, or sentences entered by a user through an input interface such as a keyboard, touch screen, or other text entry mechanism.

The term “voice input” refers to an audio signal produced by a user and captured through a microphone or equivalent device, which is then processed, for example by speech recognition, to derive linguistic content and associated features.

The term “emotion” refers to an affective state or sentiment associated with a user, such as happiness, sadness, anger, fear, surprise, or neutrality, as determined by analyzing the user's text input or voice input.

The term “response or proposal” refers to an output generated by the generative AI model in reaction to a prompt sentence, including but not limited to answers, recommendations, design suggestions, draft documents, or other forms of natural language content.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

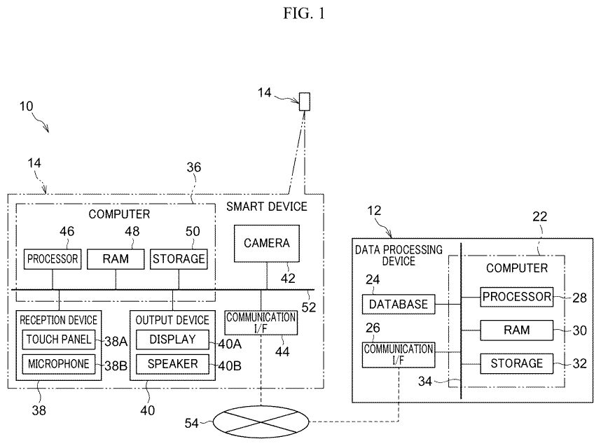

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

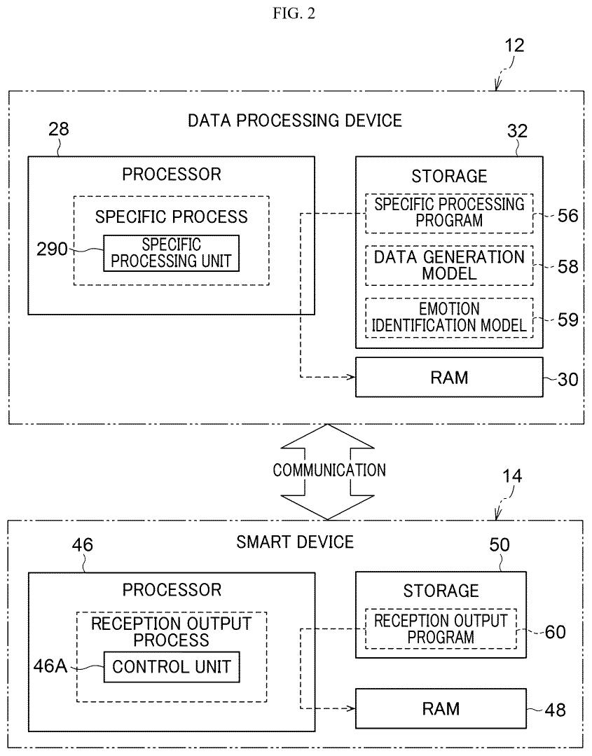

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In large-scale development and business projects, a substantial volume of unstructured natural language data is continuously generated in the form of planning documents, design specifications, meeting minutes, electronic messages, and other communication records. Conventional information processing systems primarily treat these data as text to be searched or manually reviewed, and rely on relatively simple keyword extraction or rule-based tagging. As a result, such systems are unable to build and maintain a consistent project-wide terminology set that spans heterogeneous documents and communication channels, and are further unable to reliably enforce that consistency when generating new project-related content.

This limitation creates several technical problems. First, existing systems typically process each document or message in isolation, without computing project-specific importance indices across a corpus of documents. Consequently, these systems cannot robustly identify domain-relevant words or word sequences that are important in the context of a particular project as opposed to generic language. Second, conventional systems do not automatically normalize synonymous or similar expressions into standard terms with explicit definitions stored as a reusable lexical resource. This leads to fragmentation of terminology, making automated analysis and downstream machine processing more difficult and error-prone. With the recent emergence of generative AI models, another technical deficiency becomes evident. Traditional systems forward user-authored prompts directly to a generative AI model without systematically grounding those prompts in a project-specific common language set. In such configurations, the model may generate output that introduces new terminology, misinterprets existing terms, or uses inconsistent wording across different responses. This inconsistently structured output is challenging for subsequent automated processing, such as downstream classification or aggregation, and often requires extensive manual post-processing by users.
Furthermore, when user input carries implicit contextual information, such as emotional tone or urgency, conventional systems typically do not incorporate this information into the management of terminology resources. They neither adapt the selection of standard terms nor adjust the definitions contained in a common language set based on emotion analysis. Therefore, they cannot automatically tune the terminology layer to better support context-aware prompt generation and response interpretation.
In summary, there is a need for a computer-implemented technique that: (i) automatically computes importance indices over preprocessed project text to extract significant words and word sequences; (ii) constructs and stores a project-specific common language set by integrating synonymous or similar expressions into standard terms with associated definitions and related words; (iii) automatically generates prompt sentences for generative AI models on the basis of that common language set and project background information; (iv) enforces terminology consistency in model outputs by evaluating the outputs against the common language set; and (v) optionally adjusts the common language set using emotion analysis on user input. Such a technique would improve computer processing of natural language data by providing a structured, machine-usable terminology layer that tightly couples corpus analysis, prompt generation, and generative AI interaction.

The specific processing by the specific processing unit 290 of the data processing device 12 in Example 1 is realized by the following means.

The present invention provides a server comprising a processor and a storage unit, the processor being configured to receive document data and communication data related to planning, designing, or business operations from an information processing terminal of a user; extract character information from the received document data and communication data and perform normalization processing and tokenization processing on the character information by using a natural language processing technique; apply a machine learning technique including a statistical analysis method to the tokenized character information to calculate an importance index and extract words or word sequences that are determined to be important in a project; analyze semantic relationships of the extracted words or word sequences, integrate synonymous or similar words to determine standard terms, and construct a common language set including the standard terms, definitions of the standard terms, and related words; store the common language set in the storage unit and manage the common language set as a lexical resource that is referable for each project; generate, on the basis of the common language set and background information of the project obtained from the document data or the communication data, a prompt sentence in accordance with a template so as to cause a generative AI model to execute predetermined processing; output the generated prompt sentence in a format that allows the user to view and edit the generated prompt sentence on a display device and transmit an edited prompt sentence to the generative AI model; and receive response information from the generative AI model and, while evaluating consistency of terminology in the response information based on the common language set, present the response information to the information processing terminal of the user. This enables the computing system to automatically construct and maintain a project-specific terminology resource, to generate structurally consistent prompt sentences grounded in that resource, and to enforce terminology consistency in generative AI model outputs, thereby improving the technical process of natural language analysis and generation performed by the computer.

The term “document data” refers to electronic data representing text-based materials related to planning, designing, or business operations, including but not limited to specifications, plans, reports, and meeting records.

The term “communication data” refers to electronic data representing message exchanges related to business operations, including but not limited to electronic mail, chat logs, and recorded discussion summaries.
The term “information processing terminal” refers to an information processing apparatus operated by a user, such as a general-purpose computing device capable of transmitting and receiving data to and from a server over a communication network.
The term “user” refers to a human operator who interacts with the system via an information processing terminal to provide data, review outputs, or issue commands.
The term “server” refers to a computing apparatus or group of computing apparatuses configured to execute programs, process data, and provide services to one or more information processing terminals via a communication network.
The term “processor” refers to a hardware computing element, such as a central processing unit or an execution core, that executes instructions of a computer program to perform data processing operations.
The term “storage unit” refers to a hardware storage resource, such as a memory device or a storage device, configured to store data, programs, and resources, including a common language set.
The term “character information” refers to data representing textual content composed of characters, symbols, or encoded textual units obtained from document data or communication data.
The term “normalization processing” refers to a text processing operation that converts character information into a standardized representation, such as by unifying character cases, removing unnecessary symbols, or applying formatting rules.
The term “tokenization processing” refers to a text processing operation that segments character information into smaller units, such as words, subwords, or symbols, for further analysis.
The term “natural language processing technique” refers to a computational technique for analyzing or transforming human language text, including operations such as tokenization, part-of-speech tagging, and syntactic or semantic analysis.
The term “machine learning technique” refers to a computational method that uses data-driven models to learn patterns or relationships from training data and to perform tasks such as classification, clustering, or importance estimation.
The term “statistical analysis method” refers to a mathematical procedure that uses statistical measures, such as frequency counts or weighting schemes, to evaluate properties of data, including importance indices of textual units.
The term “importance index” refers to a quantitative value computed for a word or word sequence that indicates a degree of importance or relevance of the word or word sequence within a project or corpus.
The term “word sequence” refers to a series of two or more words that appear consecutively or in a defined order in character information and are treated as a single analytical unit.
The term “semantic relationship” refers to a relationship between words or word sequences based on meaning, such as synonymy, similarity, or conceptual relatedness.
The term “standard term” refers to a canonical textual expression selected to represent a concept in a consistent manner within a project, to which synonymous or similar expressions are mapped.
The term “common language set” refers to a structured collection of standard terms, definitions of the standard terms, and related words, stored as a lexical resource for consistent terminology usage within a project.
The term “definition” refers to a textual description that explains the meaning of a standard term in the context of a project.
The term “related word” refers to a word or word sequence associated with a standard term, including synonyms, variant expressions, or conceptually linked terms.
The term “lexical resource” refers to a structured data resource that stores information about terms, such as standard terms, definitions, and relationships among terms, for use in language processing.
The term “project background information” refers to contextual information about a project obtained from document data or communication data, including objectives, constraints, requirements, and key entities.
The term “template” refers to a structured pattern or format that specifies positions or rules for inserting variable elements, such as terms or background information, when generating a prompt sentence.
The term “prompt sentence” refers to a textual input instruction generated for a generative AI model, specifying a task, constraints, or context for the model to perform predetermined processing.
The term “generative AI model” refers to an information processing model configured to generate output data, such as text, based on input data and learned parameters, including models that produce natural language responses from prompt sentences.
The term “predetermined processing” refers to a processing operation specified in advance, such as summarizing documents, extracting risks, or generating recommendations, to be executed by a generative AI model in response to a prompt sentence.
The term “display device” refers to an output apparatus that presents visual information to a user, such as a monitor, screen, or other visual display component of an information processing terminal.
The term “response information” refers to output data generated by a generative AI model in response to a prompt sentence, including textual answers, summaries, proposals, or analyses.
The term “terminology consistency” refers to a property of response information in which words and word sequences are used in alignment with the standard terms and definitions stored in the common language set.
The term “emotion analysis” refers to a processing operation that detects or estimates an emotional state, such as urgency, satisfaction, or frustration, from a user's character input or voice input by using a natural language processing technique.
The term “character input” refers to input data composed of textual characters provided by a user through an input interface, such as a keyboard or a touch-based text entry mechanism. The term “voice input” refers to audio data representing spoken language provided by a user through a sound input interface, such as a microphone.
The term “proposal information” refers to response information generated by a generative AI model that contains suggested actions, recommendations, or alternative options related to a project.
The term “success factor” refers to an element or condition identified for a project that positively contributes to achievement of project objectives.
The term “issue” refers to a problem, obstacle, or concern identified in the context of a project that may hinder smooth progress or performance.
The term “risk” refers to a potential event or condition that may adversely affect outcomes of a project, characterized by uncertainty and possible impact on objectives.

In one embodiment, a server executes a program for constructing and using a project-specific common language set in cooperation with a generative AI model. The server is implemented on general-purpose server hardware, such as a rack-mounted computing device including a multi-core central processing unit, a main memory, a nonvolatile storage device, and a network interface. The server runs an operating system such as a general-purpose server operating system and executes application software written in a high-level programming language such as a scripting language. The server further uses software libraries for natural language processing, machine learning, and neural network inference, including a natural language toolkit, a language-processing framework, and a machine learning framework.

The terminal is implemented by a client device such as a desktop computer, a notebook computer, a tablet computer, or a smartphone. The terminal executes client software, such as a web browser, and communicates with the server via a network using a communication protocol such as HTTPS. The terminal displays user interfaces, including graphical components for uploading files, reviewing generated prompt sentences, and viewing responses from a generative AI model. The user operates the terminal to supply project-related data, to confirm contents of a common language set, and to initiate interaction with the generative AI model.
The user operates the terminal to select document data and communication data stored in local storage of the terminal or in an external storage service accessible to the terminal. The terminal transmits the selected data to the server over the network. The server receives the document data and communication data and stores the received data in the storage device. The server then performs text extraction depending on file format. For example, the server uses a document processing library to obtain character information from format-specific documents such as office documents, uses a PDF processing library to obtain character information from PDF files, and uses a mail library to obtain character information from message files. For plain text and comma-separated value files, the server directly reads character information from the files. As a result, the server converts heterogeneous document formats into a unified text representation stored as a sequence of characters encoded in a standard encoding such as UTF-8.
The server applies normalization processing and tokenization processing to the character information by using a natural language processing framework. The server unifies character cases for alphabetic languages, removes control characters and non-informative symbols, and replaces sequences of whitespace with single spaces. The server uses a language model within the natural language processing framework to segment text into sentences and to segment sentences into tokens representing words or subword units. The server removes stop words according to a language-specific stop-word list and replaces inflected forms of words with lemma forms, thereby reducing sparsity of subsequent feature vectors. The server stores the tokenized and normalized text in the storage device, for example as an array of token identifiers referencing entries in a vocabulary table.
The server applies a machine learning technique including a statistical analysis method to the tokenized character information to calculate an importance index for each word or word sequence. In one embodiment, the server constructs a feature representation by mapping tokens or n-grams to numerical weights using a term-frequency inverse-document-frequency scheme implemented by a machine learning library. The server constructs a sparse matrix in which rows correspond to documents or segments and columns correspond to vocabulary items. The server computes term weights using statistical formulas that emphasize terms frequent in a subset of documents but less frequent in the overall corpus. In a variant embodiment, the server combines the statistical weights with contextual information such as part-of-speech tags from the natural language processing framework and section headings parsed from the original documents.
The server determines words or word sequences that are important for a project by sorting the importance indices and selecting items whose scores exceed a threshold. The threshold can be determined adaptively based on a distribution of indices. The server stores the selected items in a candidate term list for the project. Because the server computes importance indices over a project-wide corpus, the system can distinguish domain-relevant expressions from generic language, which improves precision of subsequent terminology construction compared to manual or single-document-based approaches.
The server analyzes semantic relationships among the extracted words or word sequences to determine standard terms. In one embodiment, the server represents each term by a vector obtained from a pre-trained word embedding model or by an embedding computed by a neural network language model hosted on the same server or on a cooperating inference server. The server computes similarity between pairs of term vectors using a metric such as cosine similarity. The server groups terms whose similarity satisfies a predetermined condition into clusters. The server further uses character-level similarity measures and pre-defined normalization rules to merge spelling variants and abbreviations. For each cluster, the server selects a representative term as a standard term, for example by choosing the most frequent or most central term according to the similarity metric.
The server constructs a common language set by associating each standard term with a definition and related words. The server can generate an initial definition using template-based generation that combines context phrases extracted from occurrences of the term in the corpus. In another embodiment, the server uses a generative AI model executing on a neural network inference engine to refine or elaborate the definition, while still constraining the generative AI model with term context and corpus-based information so that the resulting definitions remain consistent and project-specific. The server stores the common language set in a structured data format in the storage device, for example as records in a relational database table or as entries in a key-value store. Each record includes a standard term, a list of related words, a definition, and metadata such as frequency and source documents. The server manages the common language set as a lexical resource that is referable per project. The server associates an identifier with each project and links the common language set records with the project identifier. The server loads the relevant common language set into main memory when performing subsequent operations for the project, thereby reducing storage access latency. The server can maintain indexes for quick lookup of standard terms and related words. This structured management of terminology allows the server to refer to the common language set when generating prompt sentences and when evaluating responses, thereby improving processing speed and consistency compared to ad hoc, unstructured text handling.
The server generates a prompt sentence for a generative AI model on the basis of the common language set and project background information. The server maintains a set of templates, each corresponding to a specific type of processing such as summarization, risk extraction, or requirement rewriting. Each template includes fixed text segments and placeholder positions for inserting standard terms, definitions, and background information. The server selects a template according to the intended task, which may be specified by the user via the terminal or determined automatically from the type of input documents. The server fills the placeholders with data retrieved from the common language set and with summaries computed from the document data using natural language processing algorithms. For example, the server can generate a prompt sentence such as:
“Using the following common language set, describe the critical success factors for this project in a way that all stakeholders can understand. Common language set: [Go-Live Date: definition; Performance SLA: definition; Availability Target: definition; Stakeholder Approval: definition].”
In another example, the server can generate a prompt sentence such as:
“Based on the project documents and the common language set, summarize the main risks that could affect the Go-Live Date and the Performance SLA. Provide concrete mitigation strategies.”
In a further example, the server can generate a prompt sentence such as:
“Using only the terms defined in the common language set, rewrite the following requirement specification so that it is consistent and unambiguous. Requirement text: [extracted requirement paragraphs]. Common language set: [list of terms and definitions].”
The server outputs the generated prompt sentence to the terminal in a format viewable on a display device. The terminal displays the prompt sentence in a text editing component, and the user can modify or supplement the content. The terminal transmits the user-edited prompt sentence back to the server. The server forwards the prompt sentence to a generative AI model via an application programming interface. The generative AI model can be implemented as a neural network, for example a transformer-based language model composed of multiple self-attention layers, feed-forward layers, and normalization layers.
The model parameters are pre-trained on large text corpora and optionally fine-tuned on domain-specific data.
The server supplies the prompt sentence as input tokens to the generative AI model. The generative AI model converts each token into an embedding vector, propagates the vectors through its network layers, and computes output token probabilities using a softmax function. The model generates response information token by token according to the probabilities. The server receives the generated tokens from the generative AI model and reconstructs the response information as text. This neural network-based processing differs from human manual generation in that it calculates context-sensitive token distributions using high-dimensional vector operations, which are not practically executable by human operators. The server evaluates terminology consistency in the response information by comparing terms appearing in the response with the entries in the common language set. The server parses the response using the natural language processing framework to obtain tokens and phrases. The server attempts to match each content token with a standard term or a related word in the common language set. When the server detects tokens not aligned with any standard term or tokens that could be normalized to an existing standard term, the server records inconsistency indicators or suggests replacements. The server can highlight inconsistent expressions when presenting the response on the terminal and can optionally apply automatic substitution rules to rewrite the response using only standard terms before displaying it. This post-processing step produces response information that is more uniform and technically precise, and also reduces cognitive load for the user by minimizing terminology ambiguity.
In another embodiment, the server performs emotion analysis on user input for further adjusting the common language set. When the user enters character input or voice input via the terminal, the server extracts textual content. For voice input, the server uses a speech recognition component to convert audio waveforms into text. The server then applies an emotion classification model, such as a neural network that receives sequences of token embeddings and outputs probabilities for emotion categories like urgency or dissatisfaction. The server maps the classification result to adjustment rules for the common language set. For example, when the emotion analysis indicates persistent confusion or dissatisfaction related to a particular term, the server can extend or clarify the definition of that term, or adjust which standard term is chosen as representative for a cluster. By updating the lexical resource in this manner, the server can refine the terminology layer to better match project communication needs over time.
The server executes the described procedures using defined data structures and control flows rather than merely automating a human mental process. The server stores tokenized documents as structured arrays and sparse matrices, uses vector-based similarity computations and clustering algorithms to determine semantic relations, and manages the common language set as a structured lexical resource with indexes. Because the server reuses the stored common language set for multiple prompt generations and response evaluations, the server reduces redundant computation and lowers communication overhead with the generative AI model by providing more constrained and context-rich prompt sentences. As a result, the generative AI model can produce more relevant outputs with shorter prompts, which reduces transmission size and inference time.
The system provides technical effects beyond mere automation of a business workflow. By normalizing terminology and enforcing its consistent use at both the input (prompt sentence) side and the output (response information) side, the server reduces noise and ambiguity in the text processed by the neural network. This reduction in linguistic variability effectively reduces the dimensionality of the input space seen by the generative AI model for a given project, which leads to improved prediction stability and lower variance in generated outputs. Additionally, because the server precomputes importance indices and maintains a reusable common language set, subsequent processing on updated project documents can be performed incrementally, reducing processing time relative to systems that re-analyze entire corpora without reuse. The structured lexical resource also allows downstream modules, such as risk classifiers or requirement checkers, to operate on well-defined term identifiers instead of raw strings, which improves computational efficiency and accuracy.
In alternative embodiments, the server can adopt different feature extraction schemes, such as using contextual word embeddings directly from a transformer-based encoder without explicit TF-IDF weighting, or combining TF-IDF features with embedding similarities in a hybrid scoring function. The clustering algorithm for determining standard terms can be implemented as hierarchical clustering, k-means clustering, or density-based clustering. The generative AI model can be deployed locally on the same server using a dedicated inference engine with support for matrix acceleration hardware such as graphics processing units, or can be accessed as a remote service via an external network. The server can also adjust model parameters for specific projects by fine-tuning the generative AI model on project documents and the constructed common language set, using supervised learning with loss functions such as cross-entropy, and updating weights via gradient-based optimization. These variations all remain within the scope of the invention so long as the server constructs and manages a project-specific common language set and uses that set to generate and constrain prompt sentences for a generative AI model and to evaluate terminology consistency in responses. In summary, the server, the terminal, and the user cooperate to achieve a technical improvement in computer-based natural language processing. The server transforms heterogeneous document formats into structured, normalized text, computes project-specific importance indices and semantic relations to build a common language set, uses that set to generate prompt sentences for a generative AI model, and enforces terminology consistency in generated responses. This configuration improves processing speed, accuracy, and consistency of computer handling of project language compared to conventional systems that lack a project-specific lexical resource and that interact with generative AI models using unconstrained, ad hoc prompt sentences.

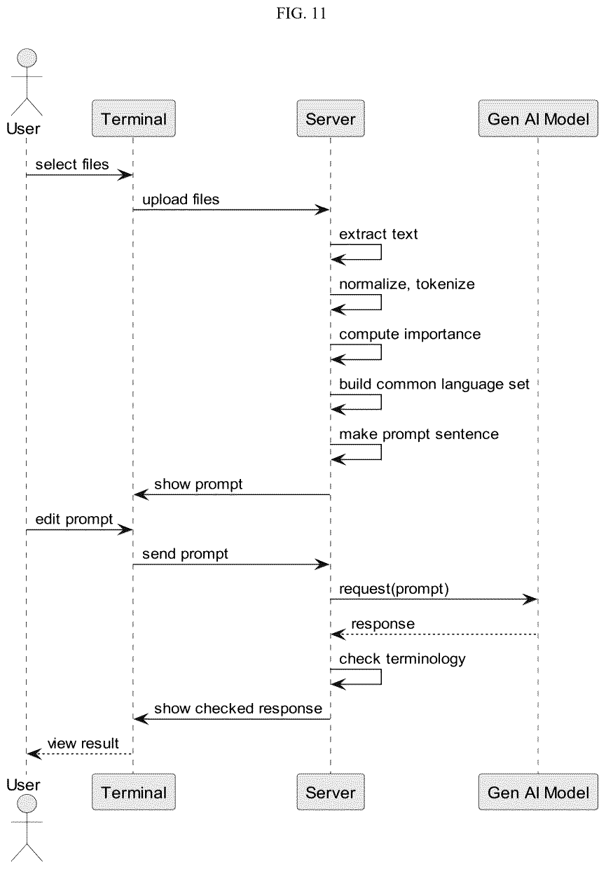

The following describes the processing flow using FIG. 11.

### Step 1:

The user operates the terminal to select project-related files and initiate upload to the server.
The input to this step is file data stored on a storage medium accessible by the terminal, such as planning documents, design documents, and communication logs.
The terminal displays a file selection interface, receives the user's selection, and packages the selected file data and metadata (project identifier, language, file type, user identifier) into a request.
The terminal transmits the request over a network connection to the server.
The output of this step is an upload request containing raw file data and associated metadata delivered to the server.

### Step 2:

The server receives the upload request and stores the raw file data and metadata in a storage unit.
The input to this step is the upload request containing document data and communication data transmitted from the terminal.
The server parses the request header and body to extract file content, stores each file in a designated directory or object store, and records metadata in a data structure, such as a database table indexed by project identifier and file identifier.
The server generates references (paths, identifiers) for the stored files and associates them with the project.
The output of this step is a set of stored file records and index entries ready for text extraction.

### Step 3:

The server extracts character information from the stored files and converts heterogeneous formats into unified text.
The input to this step is the set of stored file records and their file paths or identifiers. The server selects a text extraction routine based on file type, invokes a document library to obtain text from office documents, invokes a PDF processing library to obtain text from PDF files, uses a mail parser for message files, and reads plain text files directly.
The server concatenates or segments the extracted text into logical units (such as documents or sections) and encodes the text uniformly in a standard character encoding.
The output of this step is a collection of raw text strings associated with documents and sections, each linked to a project identifier.

### Step 4:

The server performs normalization processing and tokenization processing on the raw text strings by using a natural language processing technique.
The input to this step is the collection of raw text strings obtained in Step 3.
The server applies normalization by converting alphabetic characters to a standardized case, removing control characters and noise symbols, and standardizing whitespace.
The server loads a language model, segments the text into sentences, splits sentences into tokens, removes stop words, and applies lemmatization or stemming as configured.
The server stores the resulting tokens in structured form, such as arrays or lists associated with document identifiers.
The output of this step is a corpus of normalized and tokenized text data ready for statistical analysis.

### Step 5:

The server applies a machine learning technique including a statistical analysis method to calculate an importance index for each word or word sequence and extract important terms.
The input to this step is the corpus of normalized and tokenized text data from Step 4.
The server constructs feature vectors for documents or sections by counting occurrences of tokens or n-grams, applies a weighting scheme such as term-frequency inverse-document-frequency, and forms a feature matrix.
The server computes importance indices by aggregating weighted features across the corpus and ranking tokens and n-grams by their scores.
The server selects words and word sequences exceeding a predefined threshold or within a top-ranked range and records them as candidate project terms.
The output of this step is a list of candidate important words and word sequences, each associated with its importance index.

### Step 6:

The server analyzes semantic relationships among the candidate terms and determines standard terms to form the basis of a common language set.
The input to this step is the list of candidate important words and word sequences and, optionally, context information such as sentences in which they appear.
The server maps each candidate term into a numerical vector representation using a word embedding model or a language model, computes similarity values between term vectors, and groups terms into clusters according to similarity criteria.
The server applies additional rules, such as character-level similarity and abbreviation matching, to merge variant forms.
The server selects a representative term for each cluster as a standard term and associates other terms in the cluster as related words.
The output of this step is a set of standard terms with associated clusters of related words.

### Step 7:

The server constructs a common language set by associating each standard term with a definition and metadata.
The input to this step is the set of standard terms and their related words generated in Step 6.
The server extracts usage contexts from occurrences of the terms in the project corpus, identifies surrounding phrases and sections, and uses template rules or controlled generation to produce an initial definition text for each standard term.
The server stores, for each standard term, its related words, definition, importance indices, and source references in a structured data repository linked to the project identifier.
The output of this step is a project-specific common language set stored as a lexical resource in the server's storage unit.

### Step 8:

The server prepares project background information to be used together with the common language set when generating a prompt sentence.
The input to this step is the project corpus and the stored common language set.
The server summarizes high-level project information by aggregating headings, requirement statements, and key sentences, and optionally classifies segments into categories such as objectives, constraints, risks, and milestones using trained classifiers.
The server constructs a compact background description that refers to project goals and constraints and links them to relevant standard terms in the common language set.
The output of this step is structured project background information associated with the common language set.

### Step 9:

The server generates a prompt sentence for a generative AI model using a template populated with the common language set and project background information.
The input to this step is the common language set and the project background information obtained in Steps 7 and 8, as well as a selected task type.
The server selects a template corresponding to the task type, such as summarizing success factors, analyzing risks, or rewriting requirements, and fills placeholder fields with standard terms, definitions, and background text.
The server concatenates fixed text segments with inserted data to form a complete prompt sentence aligned with the terminology defined in the common language set.
The output of this step is at least one generated prompt sentence text configured for input to a generative AI model.

### Step 10:

The terminal presents the generated prompt sentence to the user and accepts user edits.
The input to this step is the prompt sentence text transmitted from the server.
The terminal displays the prompt sentence in an editable text field, allows the user to read the content, and receives modifications through input operations such as keyboard input or touch input.
The terminal packages the edited prompt sentence and user selection data, such as selected generative AI model or task options, and sends this information back to the server.
The output of this step is an edited prompt sentence and configuration data supplied to the server.

### Step 11:

The server transmits the edited prompt sentence to the generative AI model and obtains response information.
The input to this step is the edited prompt sentence and configuration data received from the terminal.
The server tokenizes the prompt sentence according to the input format expected by the generative AI model, encodes tokens as numerical identifiers, and generates a request to a neural network inference engine hosting the generative AI model.
The server receives output tokens from the inference engine, reconstructs them into response text, and stores the response text associated with the project and the prompt.
The output of this step is response information created by the generative AI model in reply to the edited prompt sentence.

### Step 12:

The server evaluates terminology consistency in the response information based on the common language set and prepares the response for presentation.
The input to this step is the response information from Step 11 and the common language set stored in the server.
The server tokenizes the response text, attempts to match tokens and phrases with standard terms and related words in the common language set, and identifies any terms not aligned with standard terms.
The server marks inconsistent expressions, optionally substitutes them with corresponding standard terms using predefined replacement rules, and generates an annotated or normalized version of the response.
The output of this step is processed response information in which terminology has been evaluated and optionally normalized according to the common language set.

### Step 13:

The terminal displays the processed response information to the user, enabling review and utilization.
The input to this step is the processed response information received from the server.
The terminal renders the response text in a display area, optionally highlighting terms aligned with standard terms and indicating any substitutions or comments generated by the server.
The user reads the displayed response, may save it, incorporate it into project documents, or trigger additional interactions based on the content.
The output of this step is human-readable presentation of terminologically consistent response information to the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In industrial environments, such as manufacturing and large-scale operations, a computing apparatus is often required to process heterogeneous natural language documents, including planning and design documents, operational communications, work instructions, and work reports. Conventional systems typically apply natural language processing techniques in a static and document-local manner, extracting keywords or simple entities from individual documents without constructing a coherent, system-wide representation of terminology or task structure. As a result, different subsystems and applications rely on inconsistent vocabularies, which degrades the accuracy of information extraction, complicates downstream optimization of work procedures, and limits the reliability of automated control of equipment.

Furthermore, existing systems that employ a generative artificial intelligence model generally treat the model as a black-box assistant for generating text, prompts, or summaries. They do not tightly integrate the model's output with symbolic or statistical natural language processing pipelines in a feedback loop, and they do not maintain an explicitly updated common vocabulary set and structured task data that are continuously refined across multiple document types. Consequently, the generative artificial intelligence model is not effectively aligned with domain-specific terminology, and the system cannot robustly exploit its capabilities for high-precision vocabulary extraction and information extraction that are required for optimizing machine operations.
In addition, conventional approaches to work procedure optimization and machine control frequently operate on manually curated task data or hard-coded rules, which are disconnected from the free-text instructions, reports, and communications that describe real-world operations. This disconnect introduces latency and errors in converting natural language descriptions into executable, optimized work procedures for machine equipment, thereby reducing overall system efficiency and scalability.
Moreover, user interactions and user feedback are often underutilized in current systems. Although human operators review and correct extracted information and generated procedures, such feedback is rarely reintegrated into the underlying models, prompts, or optimization conditions in a systematic, machine-usable way. As a result, the computing apparatus does not improve its extraction precision, vocabulary consistency, or optimization quality over time, and remains brittle to changes in terminology, processes, or user preferences.
Therefore, there is a need for an improved computing technology that (i) constructs and maintains a consistent common vocabulary set across multiple types of documents using natural language processing, (ii) generates and refines prompt sentences for a generative artificial intelligence model based on that common vocabulary set and structured task data, (iii) integrates outputs from the generative artificial intelligence model with classical natural language processing results to update both the vocabulary and the structured data in a closed loop, and (iv) automatically derives optimized work procedure data that can be directly used as control information for machine equipment, while incorporating user feedback to adapt the system over time. Such a system would improve the technical functioning of the underlying computing apparatus, including more efficient processing of natural language data, more accurate and consistent information extraction, and more reliable and efficient generation of control data for equipment.

The specific processing by the specific processing unit 290 of the data processing device 12 in Application Example 1 is realized by the following means.

The present invention provides a server comprising a processor configured to acquire character information from groups of documents including information related to planning and design and information related to operations, to extract words or phrases from the character information by using a natural language processing technique, to analyze part-of-speech information, occurrence frequency, and dependency relationships for the extracted words or phrases, to determine importance based on semantic relevance, and to generate a common vocabulary set having consistency across the groups of documents; to extract, as structured data, important information representing target elements, work contents, and constraint conditions from groups of documents including information related to work instructions and information related to work reports, based on the common vocabulary set and the groups of documents; to perform arithmetic processing to optimize a work sequence and a resource allocation based on the structured data and to generate optimized work procedure data for machine equipment; to generate a prompt sentence for instructing a generative artificial intelligence model to execute vocabulary extraction or information extraction processing, based on the common vocabulary set and the structured data; to input the prompt sentence and at least one of the groups of documents into the generative artificial intelligence model, to acquire words or important information output from the generative artificial intelligence model, and to integrate the acquired words or important information with extraction results obtained by the natural language processing technique to update the common vocabulary set and the structured data; and to transmit the optimized work procedure data to the machine equipment and output the optimized work procedure data as control information for improving an operation efficiency of the machine equipment. This enables an improved computing mechanism in which the server constructs and maintains a consistent domain vocabulary across heterogeneous natural language sources, tightly couples the generative artificial intelligence model with deterministic natural language processing in a feedback loop, automatically derives and refines structured task representations from unstructured text, and generates machine-usable optimized work procedure data, thereby enhancing the accuracy, robustness, and efficiency of both information processing and equipment control.

The term “processor” refers to a hardware execution unit, such as a central processing unit or a processing circuit, that executes instructions to perform arithmetic, logical, control, and input/output operations for implementing functions of the system.

The term “character information” refers to digital data representing symbols, letters, numerals, or other textual elements that can be processed as text by a computing apparatus.
The term “group of documents” refers to a collection of one or more documents that share at least one contextual or functional characteristic, such as belonging to a same project, process, or operational workflow.
The term “planning and design” refers to activities and related information for defining, specifying, or improving a product, process, or system before execution or production.
The term “operations” refers to activities and related information involved in executing tasks, processes, or workflows in an industrial or business environment.
The term “natural language processing technique” refers to a computational method or algorithm configured to analyze, interpret, or transform human language text, including at least one of tokenization, part-of-speech tagging, syntactic parsing, semantic analysis, or named-entity recognition.
The term “word or phrase” refers to a unit of text, including at least one token or a contiguous sequence of tokens, that conveys a distinct lexical meaning within a sentence or document.
The term “part-of-speech information” refers to data indicating a grammatical category of a word or phrase, such as noun, verb, adjective, or adverb, determined by linguistic analysis.
The term “occurrence frequency” refers to a numerical measure indicating how many times a given word or phrase appears in at least one document or in at least one group of documents.
The term “dependency relationship” refers to a syntactic or structural relation between words or phrases in a sentence, indicating how one word or phrase modifies or depends on another.
The term “semantic relevance” refers to a measure of conceptual or meaning-based relatedness between words, phrases, or text segments, as determined by linguistic rules, statistical models, or machine-learned representations.
The term “importance” refers to a degree indicating how significant a word or phrase is for representing content, concepts, or tasks in a given domain or document set, as determined based on at least one of semantic relevance, occurrence frequency, or dependency relationships.
The term “common vocabulary set” refers to a collection of words or phrases that are selected and normalized to represent domain-specific concepts consistently across multiple documents or document types.
The term “consistency” refers to a property in which the same or equivalent concepts are represented in a uniform manner within the common vocabulary set and across processed documents.
The term “work instructions” refers to documents that describe procedures, steps, or guidelines for performing one or more tasks in an operational workflow.
The term “work reports” refers to documents that describe results, progress, or status of executed tasks, including outcomes, issues, or performance measures.
The term “target elements” refers to entities, such as parts, components, resources, or objects, that are involved in or affected by one or more tasks described in the documents.
The term “work contents” refers to actions, procedures, or processes that are to be performed or have been performed in a task, including at least one operation or activity.
The term “constraint conditions” refers to rules, limitations, or requirements that restrict or define how tasks or operations may be executed, including at least one of temporal, logical, or resource-related constraints.
The term “structured data” refers to data that is represented in a predefined format, such as records or fields, enabling machine processing of relationships among target elements, work contents, and constraint conditions.
The term “work sequence” refers to an ordered arrangement of tasks or operations specifying a temporal or logical order in which the tasks or operations are to be executed.
The term “resource allocation” refers to an assignment of resources, including at least one of equipment, personnel, tools, or time, to tasks or operations within a work sequence.
The term “arithmetic processing” refers to computational processing, including mathematical calculations, logical operations, or optimization algorithms, executed by the processor to derive or modify data.
The term “optimized work procedure data” refers to data representing a work sequence and associated parameters that have been processed to achieve at least one performance objective, such as reduced time, reduced cost, or improved efficiency.
The term “machine equipment” refers to a physical apparatus, such as a production machine, processing unit, or automated device, that executes tasks or operations based on control information.
The term “processing apparatus” refers to a hardware system, distinct from or including machine equipment, that performs at least one processing function, such as manufacturing, inspection, or handling of material or information.
The term “generative artificial intelligence model” refers to a trained computational model configured to generate text or other output data in response to input data, based on learned patterns from training data, and including at least one neural network-based language model.
The term “prompt sentence” refers to a text string that specifies an instruction, question, or context supplied to a generative artificial intelligence model to cause the model to perform a specified processing.
The term “vocabulary extraction” refers to a process in which candidate words or phrases are identified and selected from text for inclusion in a vocabulary set.
The term “information extraction” refers to a process in which structured representations of entities, relations, or events are derived from unstructured or semi-structured text.
The term “extraction results” refers to data obtained by applying a natural language processing technique to text to identify words, phrases, entities, or structured information.
The term “update” refers to a modification operation in which existing data, such as a common vocabulary set or structured data, is changed, expanded, or refined based on new information.
The term “control information” refers to data used to configure, direct, or manage operation of machine equipment, including at least one of commands, parameters, or schedules.
The term “operation efficiency” refers to a measure of performance for machine equipment or a process, including at least one of throughput, processing time, resource utilization, or energy consumption.
The term “information terminal” refers to an electronic device, such as a workstation, portable terminal, or display device, through which a user can view information and input data to the server.
The term “user” refers to a human operator who interacts with the system via an information terminal to review, modify, or approve information or procedures.
The term “correction instruction” refers to input from a user indicating a change to extracted information, a vocabulary item, a prompt sentence, or an optimized work sequence.
The term “evaluation information” refers to input from a user indicating a quality measure, preference, or assessment regarding extracted data, prompts, or optimization results.
The term “optimization condition” refers to a parameter, rule, or objective function used by the processor when performing arithmetic processing to optimize a work sequence or resource allocation.
The term “emotion” refers to an affective state of a user, such as satisfaction, frustration, urgency, or confidence, inferred from input information.
The term “emotional state” refers to a representation of a user's emotion, classified or quantified for use in controlling processing of vocabulary or prompts.
The term “content of the common vocabulary set” refers to at least one of membership, structure, or weighting of words or phrases included in the common vocabulary set.
The term “content of the prompt sentence” refers to wording, structure, or constraints included in a prompt sentence that influence behavior of a generative artificial intelligence model.
In one embodiment, a server implements the claimed system as a combination of specialized hardware and software modules that cooperate to process heterogeneous natural language documents, construct and maintain a common vocabulary set, generate and apply prompt sentences to a generative AI model, derive structured task representations, and output optimized work procedure data as control information for machine equipment.
The server includes at least one processor, a main memory, a nonvolatile storage device, a network interface, and an interface to one or more machine equipment controllers. The processor may be implemented by a general-purpose central processing unit, such as a multi-core server-class CPU, and may be supplemented by one or more accelerator devices, such as a graphics processing unit, for executing neural network inference. The main memory stores executable program modules and runtime data structures, while the storage device stores document data, vocabulary data, model parameters, and logs. The network interface enables communication with one or more terminals and external data sources.
The server executes an operating system, such as a server-oriented operating system, and a runtime environment for an interpreted or compiled programming language, such as a Python runtime. The server deploys natural language processing libraries, such as a dependency-parsing library and a tokenization library, for example spaCy and NLTK, and a machine learning framework, such as a neural network library, for example a transformer-based library, to implement the functions described below.
The server runs a vocabulary construction module that receives and processes groups of documents, including planning and design documents and documents describing operations such as internal communications. The server acquires character information from these documents through file system access, database queries, or network transfer. The server normalizes the character information by converting it into a unified encoding, removing non-printable characters, and standardizing whitespace. The server then applies a natural language processing technique to the normalized text. For example, the server invokes a spaCy pipeline using a language model that includes tokenization, part-of-speech tagging, lemmatization, and syntactic dependency parsing. The server stores intermediate results in data structures such as token arrays, dependency trees, and document objects in main memory.
The server analyzes the tokens and syntactic structures to compute part-of-speech information, occurrence frequency, and dependency relationships for each candidate word or phrase. The server maintains, in memory or in a database, a term statistics table that records counts and co-occurrence metrics across multiple documents. The server computes semantic relevance measures, for example by projecting tokens into a word embedding space provided by the language model and calculating cosine similarity, or by counting co-occurrence frequencies within syntactic neighborhoods. Based on these metrics, the server determines importance scores for candidate terms, applies thresholds and domain-specific rules, and selects a subset of terms to store in a common vocabulary set. The server stores the common vocabulary set as a structured data object, such as a table having fields for term identifier, canonical form, part-of-speech category, importance score, and references to source documents.
By computing and materializing this common vocabulary set at the system level, the server reduces ambiguity in later extraction steps and reduces repeated processing of synonymous expressions, thereby improving precision and reducing processing time when handling large volumes of documents.
The server further runs a structured data extraction module that processes groups of documents including work instructions and work reports. The server again uses the natural language processing technique to obtain tokens, part-of-speech tags, and syntactic structures for these documents. The server then matches tokens and phrases in the work instructions and work reports with entries in the common vocabulary set, using both exact string matching and similarity-based matching in the embedding space. The server identifies target elements, work contents, and constraint conditions by recognizing patterns in the dependency trees and temporal or conditional expressions.
The server organizes these identified items into structured data representations, such as task records, resource records, and constraint records. For example, the server may generate a task record including fields describing a part identifier, an operation type, and a required machine, and may generate a constraint record describing an ordering relationship between tasks or a time limit. These structured data objects are stored in a database, enabling efficient query, update, and optimization operations without reprocessing the original natural language text.
The server then applies an optimization module that performs arithmetic processing on the structured data. The server uses algorithmic techniques such as graph-based scheduling, integer linear programming, or heuristic search to optimize a work sequence and a resource allocation. For example, the server may map tasks and constraints into a directed acyclic graph and compute a topological ordering that minimizes changeovers on specific machines, or may formulate an optimization problem over start times and machine assignments and solve it using an optimization library. The server generates optimized work procedure data containing an ordered sequence of tasks and detailed parameters, including machine identifiers, processing conditions, and timing information. Because the server operates on structured data rather than text, the optimization can be executed with predictable complexity and can be replicated across different datasets, enabling improved computational efficiency and scalability compared to manual interpretation.
To enhance the quality of vocabulary extraction and information extraction, the server incorporates a generative AI model module. In one embodiment, the generative AI model is implemented as a transformer-based neural network having multiple self-attention layers, feed-forward layers, and learned embeddings for tokens and positional information. The model parameters are stored on the storage device and loaded into memory at inference time, and may be executed on a graphics processing unit for efficient matrix computations. The generative AI model can be a large language model that has been pre-trained on a general corpus and optionally fine-tuned on domain-specific documents representing industrial terminology and task descriptions.
The server generates a prompt sentence to instruct the generative AI model. The server constructs the prompt sentence based on the current state of the common vocabulary set and the structured data. For example, the server can concatenate template text describing desired outputs with examples of terms or tasks. Representative prompt sentence examples include:
“Extract important vocabulary (key nouns and verbs) from the following work instruction. Focus on parts, operations, and process names. Output as a list of terms.
Instruction: ‘Assemble Part A after completing surface treatment of the high-strength alloy component.””
“From the following work instruction and report text, extract: (1) the parts involved, (2) the required operations, (3) the order constraints, and (4) any quality-related conditions. Respond in a concise structured description.
Text: ‘Complete surface treatment of the high-strength alloy part before assembling Part A. Perform assembly within 24 hours after surface treatment.””
“Generate a prompt sentence that can be used to extract important vocabulary from manufacturing work instructions. The prompt should instruct a large language model to focus on parts, processes, tools, and quality conditions. Output only the prompt text.”
The server submits these prompt sentences, combined with specific document text, as input to the generative AI model. The server receives the model's output as generated text and parses it to extract terms or structured descriptions. The server then merges this information with the extraction results obtained by the deterministic natural language processing pipeline. In one embodiment, the server uses a weighting scheme that assigns higher scores to items agreed upon by both the generative AI model and the deterministic pipeline, and lower scores to items proposed by only one source. The server updates the common vocabulary set and structured data accordingly, for example by adding newly discovered terms, adjusting importance scores, or refining task constraints.
This integration of the generative AI model with deterministic processing is not a mere automation of human reading. The server uses explicit, machine-optimized data structures and algorithms to combine outputs, reduce noise, and systematically propagate high-confidence information back into the vocabulary and task representations. As a consequence, the server achieves improved accuracy in identifying relevant terms and constraints, and reduces the number of passes and corrections required when processing additional documents, thereby improving overall computational efficiency.
The server further communicates with one or more terminals that provide a user interface. The terminal may be a workstation, a portable computing device, or an industrial operator panel. The terminal receives from the server, via the network interface, the optimized work procedure data, the current common vocabulary set, and the prompt sentences used for generative AI model interaction. The terminal displays these items in a structured format, such as a list of steps with highlighted terms and constraints. The user can review the displayed information and provide correction instructions or evaluation information via the terminal. The server receives such inputs, records them as feedback, and uses them to adjust thresholds, rule parameters, and prompt templates. For example, the server may increase the importance score of a term that the user repeatedly marks as relevant, or may revise a prompt sentence to emphasize certain categories of information.
In some embodiments, the server additionally analyzes user input signals, such as free-text comments or interaction patterns, to estimate a user's emotional state, for example an urgent or dissatisfied state, using a classifier trained on affective language features. The server may then adjust the granularity or tone of prompt sentences, or the level of detail displayed on the terminal, in accordance with the estimated emotional state, allowing more user-appropriate interactions without altering the underlying technical processing pipeline.
The server transmits the optimized work procedure data to machine equipment as control information. In one embodiment, the server translates each step of the optimized work procedure into machine instructions conforming to an industrial communication protocol, such as a fieldbus protocol or an OPC-based protocol. The server specifies commands to start particular operations at particular times with specified parameters, such as speed, temperature, or feed rate. By deriving these commands from systematically extracted and optimized task data, the server reduces inconsistencies and misinterpretations that can occur when operators manually translate instructions, and thereby improves the reliability and efficiency of machine operations. The optimized work procedure data may also include adaptive scheduling information that allows equipment controllers to reconfigure in response to changes in input materials or upstream conditions, which is enabled by the server's structured representation of constraints and resources.
The described architecture produces technical effects at multiple levels. Within the server, the construction and maintenance of the common vocabulary set reduces redundant parsing and disambiguation operations, improving processing speed when many similar documents are handled over time. The integration of deterministic natural language processing with a generative AI model via explicitly generated prompt sentences and weighted merging improves the precision and recall of vocabulary and information extraction beyond either method alone. The representation of extracted information as structured data enabling algorithmic optimization of work sequences and resource allocations results in more efficient internal computations when determining control commands. At the system level, the generation of optimized work procedure data directly usable by machine equipment leads to reduced machine idle time, fewer manual interruptions, and more consistent operational outcomes, contributing to improved operation efficiency.
The generative AI model itself can be trained using supervised learning or fine-tuning on domain-specific corpora. The server may store a training dataset consisting of pairs of input documents and desired outputs, such as manually curated term lists or structured task descriptions. The server defines a loss function, such as a token-level cross-entropy loss, and iteratively updates model parameters using a gradient-based optimization algorithm, such as stochastic gradient descent with adaptive learning rates. The server may apply data augmentation techniques, such as paraphrasing or synonym substitution, to increase robustness to linguistic variations. By configuring the generative AI model in this manner, the server achieves improved alignment between the model's output and the domain-specific terminology and structures used in the industrial environment.
In alternative embodiments, the server can adopt different natural language processing pipelines, such as a different parsing library or additional specialized taggers for temporal expressions, while preserving the overall structure of constructing a common vocabulary set, generating prompt sentences, interacting with a generative AI model, and updating structured data. The optimization module may also employ different algorithms, such as constraint programming or metaheuristics, depending on the complexity and size of the task graph. The system can be extended to support multiple languages by deploying multiple language-specific models and vocabulary sets, with a mapping layer that aligns terms across languages. These variations maintain the essential technical features: a server-centric architecture that tightly integrates deterministic and generative processing, maintains machine-usable domain vocabularies and structured tasks, and outputs optimized control data to machine equipment, thereby improving both computational performance and physical operation efficiency.

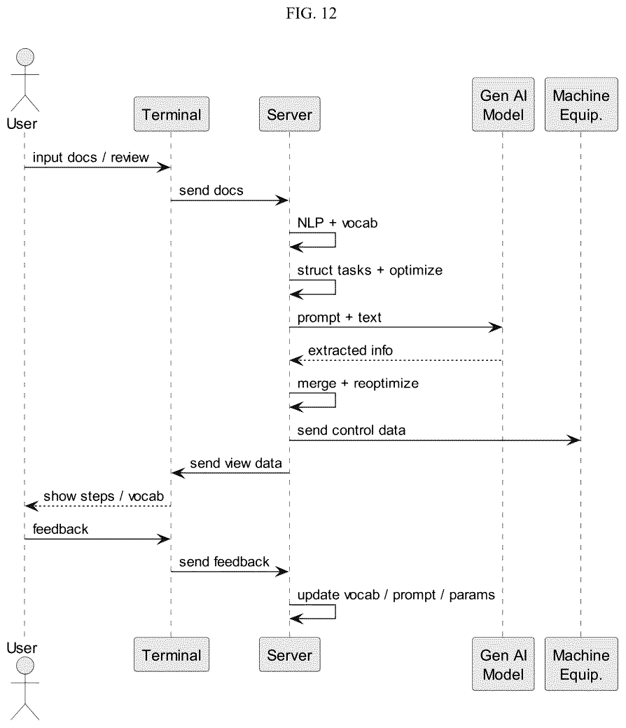

The following describes the processing flow using FIG. 12.

### Step 1:

The server acquires document data. The server receives planning and design documents and operational communication documents from a storage device or via a network interface. The input is raw text files, database records, or message payloads including character information.
The server converts the character encoding into a unified format, removes invalid control characters, and standardizes line breaks and whitespace. The output is normalized text data stored in memory as document objects ready for natural language processing.

### Step 2:

The server applies a natural language processing pipeline to the normalized documents. The server uses a language processing library to tokenize each sentence, assign part-of-speech tags, perform lemmatization, and build syntactic dependency trees. The input is the normalized text data from Step 1. The server executes algorithms that segment text into tokens, compute grammatical categories, and establish dependency relationships between tokens. The output is a set of annotated document structures that include tokens, part-of-speech information, lemmas, and dependency relations.

### Step 3:

The server constructs term statistics. The server iterates over the annotated documents and counts occurrences of each token and phrase across the document set. The input is the annotated document structures from Step 2. The server updates a term statistics table by incrementing occurrence counts, recording co-occurrence patterns, and storing basic semantic features such as embeddings or contextual vectors. The output is a term statistics data structure containing frequency values, co-occurrence metrics, and references to source documents for each candidate term.

### Step 4:

The server generates a common vocabulary set. The server evaluates importance for each candidate word or phrase using part-of-speech information, occurrence frequency, dependency roles, and semantic similarity. The input is the term statistics data structure from Step 3. The server applies thresholding, domain-specific rules, and ranking functions to filter low-importance tokens, merge synonyms, and normalize term forms. The output is a common vocabulary set that represents consistent domain terminology with associated importance scores and canonical forms.

### Step 5:

The server processes work instructions and work reports. The server acquires documents that describe work procedures and execution results from a storage device or network interface and applies the same natural language processing pipeline used in Step 2. The input is raw work instructions and work reports. The server tokenizes, tags, and parses these documents to obtain grammatical and syntactic structures. The output is a set of annotated work instruction and work report structures that are aligned with the vocabulary analysis.

### Step 6:

The server matches document content with the common vocabulary set. The server compares tokens and phrases in the annotated work instructions and work reports with entries in the common vocabulary set using both exact string matching and similarity measures in an embedding space. The input is the common vocabulary set from Step 4 and the annotated work documents from Step 5. The server computes similarity scores, resolves ambiguous matches, and flags relevant tokens and phrases as references to domain terms. The output is a set of link records that associate document segments with vocabulary entries and identify candidate target elements, work contents, and constraint expressions.

### Step 7:

The server generates structured task data. The server analyzes the linked document segments and dependency structures to extract task units, resources, and constraints. The input is the link records from Step 6 and the annotated work documents. The server groups related tokens into tasks, identifies parts and operations, detects temporal expressions such as “before” or “within 24 hours,” and encodes these findings into task records, resource records, and constraint records. The output is structured data representing tasks, their required resources, and logical or temporal constraints between tasks.

### Step 8:

The server optimizes work sequences and resource allocations. The server applies an optimization algorithm to the structured task data to determine an efficient execution order and machine assignment. The input is the structured data from Step 7. The server constructs a mathematical model or a graph-based representation, defines an objective function such as minimizing machine changeovers or total processing time, and computes an optimized schedule using optimization routines. The output is optimized work procedure data that specifies an ordered list of operations, assigned machines, and timing parameters.

### Step 9:

The server generates a prompt sentence for a generative AI model. The server constructs an instruction text that describes what information should be extracted or refined by the generative AI model, using elements from the common vocabulary set and the structured task data. The input is the common vocabulary set from Step 4 and the structured data from Step 7 or Step 8. The server selects representative terms, operations, and constraints, and embeds them into template phrases. The output is a prompt sentence tailored for vocabulary extraction or information extraction, for example: “Extract important vocabulary (key nouns and verbs) from the following work instruction. Focus on parts, operations, and process names. Output as a list of terms. Instruction: ‘Assemble Part A after completing surface treatment of the high-strength alloy component.””

### Step 10:

The server queries the generative AI model using the prompt sentence. The server sends the prompt sentence and relevant document text to the generative AI model through an inference interface. The input is the prompt sentence from Step 9 and one or more documents such as a work instruction or work report. The server transmits this input to the generative AI model, which executes neural network inference to generate output text containing extracted terms or structured descriptions. The output is generated text that lists important vocabulary or describes extracted parts, operations, constraints, or conditions.

### Step 11:

The server parses and integrates the generative AI model output. The server interprets the generated text by splitting it into tokens, matching them with existing vocabulary entries, and identifying new candidate terms or corrections. The input is the generated output text from Step 10 and the existing common vocabulary set and structured data. The server performs parsing, normalization, and comparison operations to align the generative AI model's output with deterministic extraction results, and it applies weighting or conflict-resolution rules to merge the information. The output is an updated common vocabulary set and updated structured data that reflect both deterministic and generative extraction.

### Step 12:

The server generates final optimized work procedure data for machine control. The server refines the optimization results by using the updated structured data, optionally re-evaluating constraints and resource usage if new information was added or corrected. The input is the updated structured data from Step 11 and the previous optimization result from Step 8. The server recalculates task ordering or parameter settings as needed and formats the final optimized work procedure data into machine-readable control messages. The output is finalized control information including command sequences, parameter sets, and scheduling data for machine equipment.

### Step 13:

The server transmits the optimized work procedure data to machine equipment. The server uses an industrial communication protocol to send control messages to controllers of machine equipment. The input is the finalized control information from Step 12. The server establishes a communication session, encodes the commands and parameters according to the protocol specification, and transmits them to the equipment. The output is the activation of machine operations executed according to the optimized work procedure, resulting in controlled motion, processing, or handling by the equipment.

### Step 14:

The server sends visualization data to the terminal. The server prepares a representation of the optimized work procedure data, the common vocabulary set, and the prompt sentences for display. The input is the updated vocabulary, structured data, and optimized procedure from previous steps. The server formats this information as display-oriented data structures, such as lists of steps and highlighted terms, and sends them to the terminal via a network interface. The output is a user-interface dataset that the terminal can render for human review.

### Step 15:

The terminal displays information and collects user feedback. The terminal receives the visualization data from the server and renders work steps, associated vocabulary items, and prompt sentences on a display device. The input is the user-interface dataset from Step 14. The terminal allows the user to select items, correct terms, annotate constraints, or rate the quality of extracted information and optimized sequences. The output is user feedback data including correction instructions and evaluation information.

### Step 16:

The server updates system parameters based on user feedback. The server receives the feedback data from the terminal and applies it to adjust internal data structures and control parameters. The input is the user feedback from Step 15 and the current common vocabulary set, prompt sentence templates, and optimization conditions. The server modifies importance scores, adds or removes vocabulary entries, refines prompt sentence wording, and tunes optimization objective weights according to the feedback. The output is an adapted configuration of the vocabulary set, prompt sentence templates, and optimization parameters, which will be used as input in subsequent executions to improve extraction accuracy, optimization quality, and computational efficiency.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In large-scale information processing environments, such as enterprise document management systems and collaborative communication platforms, computer systems increasingly rely on natural language input to control automated processing. Conventional systems typically generate prompts for generative artificial intelligence models directly from user-provided text or from isolated document fragments. In such systems, a processor often treats heterogeneous vocabularies, domain-specific jargon, abbreviations, and inconsistent expressions as independent tokens without establishing a stable semantic normalization across documents, projects, or users.

As a result, the same concept may be expressed by many different linguistic expressions across information records and dialogue records. When prompt sentences for generative AI models are constructed directly from such inconsistent linguistic expressions, the prompts tend to be ambiguous, incomplete, or semantically noisy. This leads to degraded performance of downstream generative AI tasks, such as automatic drafting, summarization, classification, or decision support, because the model receives instructions that do not reflect a consistent “common language” within the target domain.
Furthermore, conventional prompt-generation mechanisms generally do not utilize structured semantic clustering of terms. Typical approaches may rely on simple keyword extraction, rule-based templates, or ad-hoc heuristics without computing explicit feature vectors or similarity measures for vocabulary items. This makes it difficult for the computer system to dynamically organize linguistic expressions into semantically coherent groups, to label those groups in a machine-usable manner, and to reuse such group information across tasks. Consequently, the computer system cannot systematically improve the precision and stability of prompts, nor can it adaptively refine its internal representations based on historical interaction with generative AI models.
In addition, conventional systems often lack a closed feedback loop in which the results of semantic grouping, similarity computation, and model responses are recorded and reused to optimize subsequent processing. Even when user interfaces allow users to review or edit vocabulary lists, those corrections are seldom fed back into the underlying clustering logic or prompt-generation logic at a system level. This prevents the system from improving its internal models and parameters over time and from achieving higher robustness and efficiency in handling evolving vocabularies.
Accordingly, there is a need for an improved computer-implemented technique that (i) extracts linguistic expressions from heterogeneous information records and dialogue records, (ii) computes semantic relatedness by using language processing resources to form common term groups, (iii) leverages feature vectors and similarity calculations to iteratively refine those groups, (iv) constructs a structured common language set with machine-generated group names suitable for prompt construction, and (v) maintains historical data to automatically adjust clustering and prompt-generation conditions. Such a technique should improve the operation of the computer itself, by reducing ambiguity and redundancy in internal language representations and by enabling the processor to generate more precise, stable, and task-appropriate prompt sentences for generative AI models.

The specific processing by the specific processing unit 290 of the data processing device 12 in Example 2 is realized by the following means.

The present invention provides a server comprising a processor and a memory storing instructions that, when executed by the processor, cause the processor to extract linguistic expressions from information records and dialogue records, analyze semantic relatedness of the extracted linguistic expressions as numerical data by using language processing resources and lexical resources, classify the linguistic expressions into a plurality of groups based on the numerical data to generate common term groups, generate feature vectors for the common term groups by using a semantic representation model, calculate similarity on the basis of the feature vectors to update compositions of the common term groups, generate, for each of the common term groups, a prompt sentence to be presented to a generative information processing model, input the prompt sentence into the generative information processing model to obtain an abstract group name or a descriptive text representing the common term group, associate the group name or the descriptive text with the common term group to construct a common language set, generate an additional prompt sentence for specifying an information processing task on the basis of the common term groups and the group names included in the common language set, input the additional prompt sentence into the generative information processing model, transmit the common language set to a terminal device, receive user-driven updates of the common term groups via the terminal device, and store history information including feature vectors, similarity data, group classification results, and response data obtained from the generative information processing model, and automatically adjust subsequent group classification conditions or prompt sentence generation conditions based on the history information. This enables the computer system to internally normalize heterogeneous vocabularies into semantically consistent common term groups, to generate higher-quality and more task-appropriate prompt sentences for generative AI models, and to iteratively optimize its clustering and prompt-generation logic over time, thereby improving the accuracy, robustness, and efficiency of computer-implemented information processing.

The term “information record” refers to any electronically stored or electronically represented item that contains language data related to planning, design, operation, or other activities, including but not limited to documents, files, messages, logs, and structured or unstructured data entries.

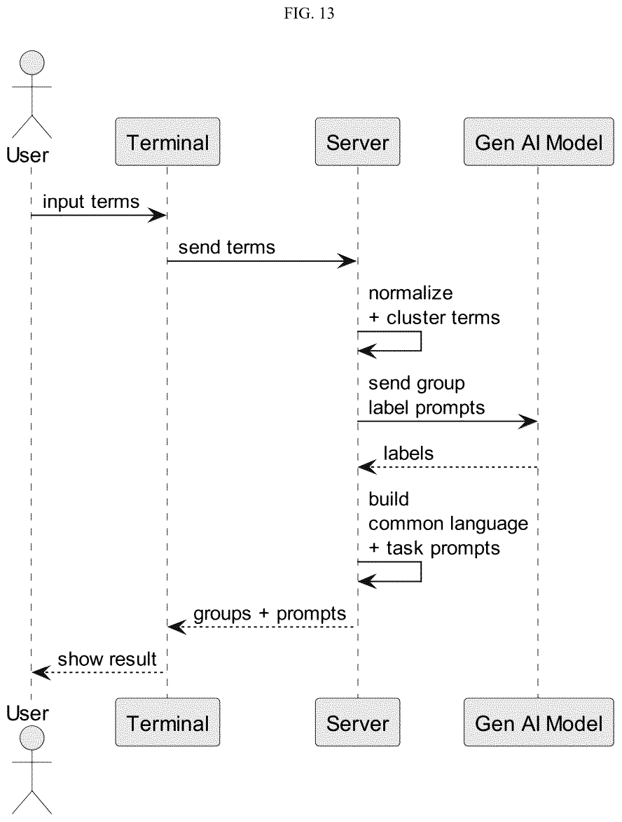

The term “dialogue record” refers to any electronically captured representation of communication between two or more entities, including but not limited to transcripts, chat logs, email threads, meeting minutes, and records of spoken or written exchanges.
The term “linguistic expression” refers to any unit of language extracted from an information record or a dialogue record, including but not limited to words, phrases, terms, collocations, or other text segments used to express concepts.
The term “language processing resource” refers to any computational component used to process natural language, including but not limited to tokenizers, parsers, lemmatizers, part-of-speech taggers, and semantic analyzers implemented in software or hardware.
The term “lexical resource” refers to any data structure or storage that provides information about words or terms, including but not limited to dictionaries, thesauri, ontologies, term lists, synonym sets, and domain-specific glossaries.
The term “semantic relatedness” refers to a degree of relationship between linguistic expressions based on meaning, which may be quantified as a numerical value derived from definitions, usage contexts, feature vectors, or statistical models.
The term “numerical data” refers to a representation of semantic relatedness or other language characteristics as one or more numerical values, including but not limited to similarity scores, distance measures, or weighting coefficients.
The term “common term group” refers to a set of two or more linguistic expressions that are classified together based on semantic relatedness and treated as representing a shared or closely related concept within a domain.
The term “semantic representation model” refers to a computational model that maps linguistic expressions to feature vectors, including but not limited to embedding models, language models, and neural network-based text representations.
The term “feature vector” refers to a numerical vector generated by a semantic representation model that encodes semantic or contextual properties of a linguistic expression or a group of linguistic expressions.
The term “similarity” refers to a quantitative measure of how closely related two feature vectors are, which may be computed by a mathematical operation such as cosine similarity, Euclidean distance, or another metric.
The term “composition of the common term group” refers to a membership structure that specifies which linguistic expressions are included in a particular common term group at a given time.
The term “generative information processing model” refers to a computational model capable of generating text or other content in response to input data, including but not limited to a generative AI model, a large language model, or another generative neural network.
The term “prompt sentence” refers to a sequence of one or more linguistic expressions that is provided as input to a generative information processing model to instruct the model to perform a particular operation or to generate a particular output.
The term “abstract group name” refers to a concise linguistic expression generated by a generative information processing model that denotes a generalized concept corresponding to a common term group.
The term “descriptive text” refers to one or more sentences or phrases generated by a generative information processing model that explain, characterize, or summarize the semantic content of a common term group.
The term “common language set” refers to a structured collection that associates common term groups with corresponding abstract group names or descriptive texts and that is used as a normalized representation of vocabulary within a system.
The term “information processing task” refers to any operation performed by a computer system based on input data, including but not limited to generating documents, summarizing content, classifying items, retrieving information, or providing recommendations.
The term “terminal device” refers to any computing apparatus used by a user to interact with the server, including but not limited to a personal computer, a mobile device, a tablet device, or a network-connected client device.
The term “display information” refers to data formatted for presentation on an output interface of a terminal device, including but not limited to graphical user interface elements, text lists, tables, and interactive controls.
The term “history information” refers to stored data that records past processing states or results, including but not limited to feature vectors, similarity values, group classification outputs, prompt sentences, and responses generated by a generative information processing model.
The term “group classification condition” refers to one or more parameters or rules used by a processor to determine membership of linguistic expressions in common term groups, including but not limited to similarity thresholds, clustering parameters, and weighting factors.
The term “prompt sentence generation condition” refers to one or more parameters or rules used by a processor to construct a prompt sentence, including but not limited to template structures, selection of terms, inclusion of group names, and formatting constraints.
The term “recording medium” refers to any physical or virtual storage used to retain data, including but not limited to semiconductor memory, magnetic storage, optical storage, and network-based storage services.
The term “user-driven update” refers to a modification to one or more elements of the common language set that is initiated or confirmed by a user through an input interface of a terminal device.
In one embodiment, a server cooperates with one or more terminals operated by users to construct and maintain a common language set for guiding a generative AI model through structured prompt sentences. The server includes at least one processor, a memory, one or more storage devices, and a communication interface connected via a network to the terminals. The server executes software components including an application server module, a natural language processing module, a semantic representation module, a clustering module, a generative AI interface module, and a history management module.
The server runs on a general-purpose computing platform, such as a rack-mounted server or a virtual machine provided by a cloud computing environment and equipped with a central processing unit and, in some embodiments, one or more graphics processing units for accelerating neural network inference. The server uses a conventional operating system and middleware, and the application server module may be implemented using a web framework such as a scripting-language framework, an interpreted-language framework, or a compiled-language framework. The server exposes an application programming interface accessed by the terminals through a network protocol.
The terminal is a computing device such as a personal computer, a mobile device, or a tablet device. The terminal executes a web browser or a native client application and provides a graphical user interface that enables the user to input linguistic expressions, send processing requests to the server, and display structured common term groups and related prompt sentences. The terminal includes an input interface such as a keyboard, a pointing device, or a touchscreen, and a display interface.
The user uses the terminal to access a user interface for vocabulary analysis and prompt construction. The user inputs linguistic expressions that have been extracted from information records and dialogue records, such as project planning documents, design specifications, chat logs, and meeting notes. The user may input simple examples such as “dog, cat, car, bus” or more domain-specific terms such as “SLA, service level agreement, response time, uptime, downtime.” The terminal converts the user's input into an internal representation and transmits it to the server via the communication interface.
The server receives text data from the terminal and stores the received linguistic expressions in a data structure such as a list or an array in memory. The server uses a natural language processing module, which may internally employ tokenization, part-of-speech tagging, and lemmatization algorithms, to normalize the linguistic expressions. For example, the server converts uppercase letters to lowercase letters, removes redundant punctuation, and applies lemmatization so that plural forms are mapped to their singular base forms. The server may use a language processing library that implements such algorithms and relies on language models trained on large text corpora.
The server accesses lexical resources stored in a storage device. The lexical resources may include dictionaries, thesauri, ontologies, and domain-specific term lists stored in a relational database or a key-value store. The server retrieves, for each normalized linguistic expression, associated information such as definitions, synonyms, and part-of-speech types by executing queries against the lexical resources. The server caches the retrieved lexical entries in main memory using a map structure that associates each term with its lexical metadata.
The server uses a semantic representation module to convert each linguistic expression into a numerical feature vector. The semantic representation module includes a neural network-based embedding model that receives tokenized text as input and outputs a fixed-dimensional vector representation. The server may employ a transformer-based encoder architecture with multiple attention layers, feed-forward layers, and layer normalizations. The server initializes this model with parameters obtained from pretraining on large-scale text data, and in some embodiments, the server further fine-tunes the model using domain-specific term pairs or sentence pairs to reduce domain mismatch. The server uses a feature extractor component that takes the hidden state of a special token or an averaged hidden state across tokens to produce a feature vector for each linguistic expression.
The server calculates semantic relatedness between linguistic expressions using the generated feature vectors. The server uses a numerical computation library to compute similarity measures, such as cosine similarity, between vectors representing different terms. The server forms a similarity matrix where each matrix element holds a real-valued similarity score for a pair of linguistic expressions. The server may normalize the similarity scores or apply a threshold to ignore pairs with similarity below a predetermined value. By representing semantic relatedness as numerical data, the server is able to perform consistent and repeatable grouping operations that are not practical for human operators to perform manually at scale.
The server applies a clustering module to the feature vectors or to the similarity matrix. The clustering module implements one or more unsupervised learning algorithms, such as hierarchical agglomerative clustering, partition-based clustering, or density-based clustering. The server sets clustering parameters, such as the number of clusters, a distance threshold, or a minimum number of members, according to system configuration or adaptively according to past performance recorded by the history management module. The server assigns each linguistic expression to a common term group based on the clustering results. The server stores the grouping as a group assignment data structure, for example as a list of group identifiers associated with term identifiers.
The server updates the composition of each common term group by iteratively recalculating similarity based on group-level feature vectors. The server generates, for each common term group, a group feature vector that may be computed by averaging the feature vectors of all member terms or by applying a weighted combination that emphasizes more frequent or central terms. The server recalculates similarity between group feature vectors and term feature vectors and may reassign outlier terms to different groups when the similarity with their current group falls below a threshold. This iterative refinement process enables the server to converge to more semantically coherent common term groups.
The server constructs a common language set that associates each common term group with metadata including a group identifier, a list of member linguistic expressions, and labels or descriptions generated by a generative AI model. The server uses a generative AI interface module to communicate with a generative information processing model. The generative information processing model is a neural network-based text generation model with an encoder-decoder or decoder-only architecture trained to predict next tokens given an input sequence. The server connects to such a model running locally on a machine equipped with a parallel processing unit or to a remote model endpoint provided over a network.
The server generates a prompt sentence for each common term group to obtain an abstract group name or descriptive text. The server constructs the prompt sentence by embedding a list of member terms into a predefined template. Examples of such prompt sentences include: “Please provide a short, general label that describes the common concept represented by the following terms: dog, cat.”
“Below is a list of terms. Group them into semantically related categories and give a short label for each category. Terms: dog, cat, car, bus.”
“Group the following business terms into common language clusters and explain the rationale for each cluster: SLA, service level agreement, response time, uptime, downtime.”
The server sends each prompt sentence to the generative information processing model via the generative AI interface module. The model encodes the prompt sentence into internal token embeddings, propagates them through stacked attention layers and feed-forward layers, and produces output token probabilities at each decoding step. The server decodes the model's output sequence using a decoding strategy such as greedy decoding, beam search, or sampling with temperature, and obtains an output text that contains an abstract group name or descriptive text for the common term group, for example “animals” for the group containing “dog” and “cat,” or “vehicles” for the group containing “car” and “bus.”
The server associates the generated abstract group name or descriptive text with the corresponding common term group in the common language set. The server stores this association in a persistent storage device using a structured schema that includes group identifiers, member term identifiers, generated labels, and timestamps. Because the server consistently uses machine-computed feature vectors and similarity metrics, the common language set reflects a stable mapping between the vocabulary of the information processing environment and higher-level conceptual labels.
The server generates an additional prompt sentence for specifying an information processing task based on the common language set. The server may embed one or more group names and representative terms into a task-specific prompt template, such as:
“Using the following common language definitions, draft a summary of the project requirements: animals (dog, cat), vehicles (car, bus).”
“Using the following normalized terminology (SLA, response time, uptime, downtime), generate a service agreement outline that consistently uses these terms.”
The server uses prompt sentence generation conditions, including template selection, maximum prompt length, and ordering of groups, that are stored in configuration data. The server may adjust these conditions based on historical performance stored by the history management module, for example by preferring templates that previously yielded higher user satisfaction or lower correction rates.
The server transmits the common language set and the generated prompt sentences to the terminal through the communication interface. The terminal receives the data and updates the graphical user interface so that the user can review the common term groups, the generated abstract group names, and the suggested task-specific prompt sentences. The terminal displays the groups in a structured format, such as a list of sections labeled by the abstract group names, with each section showing its member terms.
The user inspects the displayed common language set and may choose to edit group membership, rename groups, or remove or add terms. The terminal captures user-driven updates and sends updated group information back to the server. The server receives the updates and modifies the group assignment data structures and the common language set accordingly. The server records both the original grouping and the user-modified grouping in the history management module.
The server maintains history information in a recording medium, including feature vectors of terms and groups, similarity matrices, clustering parameters, group assignment results, and outputs obtained from the generative information processing model. The server analyzes the history information to adjust subsequent group classification conditions and prompt sentence generation conditions. For example, if history shows that certain clustering parameters repeatedly lead to user corrections, the server modifies similarity thresholds or cluster size constraints to reduce future mis-groupings. If certain prompt templates produce outputs that require frequent manual revision, the server de-emphasizes or modifies those templates. The server thereby improves the operation of the computer system by reducing redundant and inconsistent internal representations of vocabulary. The computation of feature vectors and similarity metrics allows the server to organize linguistic expressions in a high-dimensional semantic space, which is not feasible with straightforward keyword matching. This results in more accurate clustering and more reliable prompt construction, which in turn improves the quality and stability of responses from the generative information processing model. Because the server uses structured numerical representations and algorithmic clustering rather than ad-hoc or purely human-curated lists, the system scales to large vocabularies and automatically adapts to evolving terminology.
The server further improves computational efficiency by reusing previously computed feature vectors and similarity scores stored in the history management module. When the server encounters a linguistic expression that has been processed before, the server retrieves the stored feature vector instead of re-computing it, thereby reducing processing time and processor load. By storing and reusing similarity matrices and clustering results, the server avoids recomputing entire group structures when only a small number of new terms are added, which reduces unnecessary numeric computation and lowers energy consumption.
The server also reduces communication load between the server and the terminals. Instead of transmitting entire raw corpora of documents or dialogues, the server and terminals mainly exchange compact representations such as lists of terms, group identifiers, and labels. This structure allows the system to operate efficiently in networked environments with limited bandwidth and to accelerate user interaction by transmitting only the information necessary for review and correction.
The server implements a learning loop that is distinct from ordinary human work automation. The server does not merely replicate a human operator's manual grouping or labeling; instead, the server employs non-intuitive, high-dimensional vector-based similarity calculations, unsupervised clustering algorithms, and template-based prompt construction rules that depend on numerical thresholds and error statistics derived from history information. The server may use regularization techniques, learning-rate schedules, and loss functions such as cross-entropy loss during model fine-tuning to improve the semantic representation model. The server thereby enhances the internal data structures that represent language, leading to reduced error rates in grouping and improved consistency across tasks. In other embodiments, the server may adopt alternative neural architectures for the semantic representation model, such as convolutional neural networks for text, recurrent neural networks with attention, or combinations thereof. The server may use different similarity measures, including but not limited to dot-product similarity or Mahalanobis distance, and may apply dimensionality reduction techniques to feature vectors to improve clustering performance. The clustering module may select different algorithms adaptively based on vocabulary size or term distribution, such as using a density-based algorithm for very large and sparse vocabularies and a hierarchical algorithm for smaller and more cohesive vocabularies.
In further embodiments, the server may integrate specialized domain lexicons or ontologies to constrain or guide the clustering process. For example, the server may impose constraints preventing certain technical terms from being grouped with general language terms if domain metadata indicates distinct usage patterns. Such rule-based constraints are combined with vector-based similarity to yield a hybrid grouping method that further increases precision. In additional embodiments, the server may generate different types of prompt sentences for different categories of tasks, such as summarization, classification, or document drafting, by using different templates and by emphasizing different elements of the common language set. The server may also maintain separate common language sets for different projects or departments and may merge or split these sets based on similarity metrics computed over group feature vectors.
By implementing these structures and operations, the server improves the functioning of the underlying computer system. The server accelerates processing by reusing learned representations and cached similarity computations, reduces memory overhead by sharing feature vectors across multiple tasks, and reduces network traffic by transmitting compact group structures instead of raw text. The server also reduces error rates in generative AI outputs by providing more coherent, semantically normalized prompt sentences that reflect the internal organization of the vocabulary space. The technical effect is a computer system that operates with higher precision, lower latency, and greater robustness when handling large-scale, heterogeneous language data for generative AI applications.
The following describes the processing flow using FIG. 13.

### Step 1:

The user operates the terminal to input linguistic expressions.
The user opens an application screen on the terminal and types or pastes one or more terms, for example “dog, cat, car, bus,” into a text input field.
The terminal receives the raw text as input, parses the text string by delimiters such as commas or line breaks, and converts it into an internal list of strings.
The terminal outputs the list of linguistic expressions (e.g., [“dog”, “cat”, “car”, “bus”]) as a request payload and prepares to transmit it to the server.

### Step 2:

The terminal sends the linguistic expressions to the server.
The terminal takes the list of strings as input and encapsulates the list in a request message formatted, for example, as a structured object with a field for the term list.
The terminal performs a network operation to send the request to the server via a communication interface, and sets appropriate headers and metadata.
The terminal outputs a network packet containing the linguistic expressions as payload and transmits the packet over a network to the server.

### Step 3:

The server receives and validates the linguistic expressions.
The server accepts the network packet as input through a network interface and extracts the request message from the packet.
The server parses the request message to obtain the list of linguistic expressions and checks that each element is a non-empty string. The server removes duplicates and trims whitespace from each element.
The server outputs a cleaned list of linguistic expressions, for example [“dog”, “cat”, “car”, “bus”], as an internal data structure stored in memory.

### Step 4:

The server normalizes the linguistic expressions using language processing resources. The server takes the cleaned list as input and applies tokenization and lemmatization using a natural language processing library.
The server converts each term to lowercase, removes leading and trailing punctuation symbols, and, if possible, maps inflected forms to base forms (for example, “dogs” to “dog,” “cars” to “car”).
The server outputs a normalized term list, such as [“dog”, “cat”, “car”, “bus”], where each element is a canonical representation used for subsequent processing.

### Step 5:

The server enriches the normalized terms with lexical information.
The server uses the normalized term list as input and issues queries to lexical resources, such as dictionaries and thesauri stored in a database.
The server retrieves definitions, synonyms, and part-of-speech tags for each term and aggregates this information into structured entries, for example a mapping from each term to its lexical metadata.
The server outputs a lexical information map that associates each normalized linguistic expression with its retrieved lexical attributes.

### Step 6:

The server generates feature vectors for the normalized terms using a semantic representation model.
The server takes the normalized term list as input and passes each term through a neural network-based embedding model that encodes the term into a numerical feature vector. The server applies tokenization, converts tokens into token IDs, feeds them into the model's layers (attention layers, feed-forward layers), and obtains hidden states that are pooled to form a fixed-length vector for each term.
The server outputs a feature matrix in which each row corresponds to a term and each row element is a component of the term's feature vector.

### Step 7:

The server computes semantic similarity between pairs of terms.
The server uses the feature matrix as input and calculates similarity scores between each pair of feature vectors using a mathematical operation such as cosine similarity.
The server iterates over all term pairs, applies the similarity formula to the corresponding vectors, and stores the resulting numerical similarity values in a two-dimensional matrix. The server outputs a similarity matrix in which each cell holds a real-valued measure of semantic relatedness between two normalized linguistic expressions.

### Step 8:

The server clusters the terms into common term groups based on the similarity matrix. The server takes the similarity matrix as input and applies a clustering algorithm, such as hierarchical agglomerative clustering or another unsupervised method, using predefined group classification conditions like distance thresholds.
The server groups terms that have similarity scores above a threshold into the same cluster and assigns a group identifier to each cluster. For example, the server may group “dog” and “cat” together and “car” and “bus” together.
The server outputs a group assignment structure that associates each normalized term with a common term group identifier.

### Step 9:

The server refines group compositions using group-level feature vectors.
The server uses the group assignment structure and the term feature matrix as input and calculates a group feature vector for each common term group, for example by averaging the feature vectors of the group's member terms.
The server recomputes similarity between each term feature vector and each group feature vector and checks whether some terms are closer to other groups than to their current group. The server reassigns such terms when similarity falls below or exceeds specified thresholds and outputs an updated group assignment structure with refined common term group compositions.

### Step 10:

The server constructs a common language set from the refined common term groups. The server takes the updated group assignment structure and the normalized term list as input and organizes the data into a higher-level structure that includes, for each common term group, its identifier and its member terms.
The server adds linkage fields to store group labels and descriptive texts that will be obtained later from a generative AI model.
The server outputs a preliminary common language set data structure, with each common term group represented as a record containing group metadata and member terms.

### Step 11:

The server generates prompt sentences for obtaining group labels from a generative AI model.
The server uses the preliminary common language set as input and, for each common term group, constructs a text string that lists group member terms and requests a label.
The server embeds the term list into a template to create a prompt sentence, for example: “Please provide a short, general label that describes the common concept represented by the following terms: dog, cat.”
The server outputs a set of prompt sentences, each associated with a corresponding common term group identifier.

### Step 12:

The server sends the prompt sentences to a generative AI model and receives group labels or descriptions.
The server takes each prompt sentence as input and submits it to a generative information processing model via an interface module, using an application protocol.
The server causes the model to process the prompt sentence, generate output tokens step by step, and return a text sequence that contains an abstract group name or descriptive text. For example, the model may return “animals” for the group {dog, cat} and “vehicles” for the group {car, bus}.
The server outputs a mapping from each group identifier to the generated abstract group name or descriptive text.

### Step 13:

The server associates the generated labels with the common term groups and finalizes the common language set.
The server uses the preliminary common language set and the mapping from group identifiers to labels as input and updates each group record to include the generated abstract group name or descriptive text.
The server stores these updated records in persistent storage and organizes them as a finalized common language set that provides normalized terminology and human-readable group names.
The server outputs the finalized common language set as a structured object ready for use in subsequent information processing tasks and for transmission to terminals.

### Step 14:

The server generates task-specific prompt sentences using the common language set.
The server takes the finalized common language set as input and constructs additional prompt sentences that reference the group names and representative terms for a particular task, such as summarization or document drafting.
The server selects a prompt template, inserts one or more group names and member terms, and produces a complete task instruction, for example: “Using the following common language definitions, draft a summary of the project requirements: animals (dog, cat), vehicles (car, bus).”
The server outputs a collection of task-specific prompt sentences that are optimized for clarity and semantic consistency based on the common language set.

### Step 15:

The server transmits the common language set and related prompt sentences to the terminal. The server uses the finalized common language set and the generated prompt sentences as input and wraps them into a response message formatted as structured data.
The server sends the response message through the communication interface to the terminal, ensuring that group identifiers, group names, member terms, and example prompt sentences are included.
The server outputs a network packet that delivers the common language set and associated information to the terminal.

### Step 16:

The terminal displays the common language set and receives user-driven updates.
The terminal takes the server's response message as input, parses the structured data, and constructs user interface elements for each common term group.
The terminal displays group names, member terms, and example prompt sentences to the user and allows the user to perform operations such as editing group memberships, renaming groups, or marking incorrect labels.
The terminal outputs updated group configurations as new request messages to the server whenever the user performs such modifications.

### Step 17:

The server records history information and adjusts future processing conditions.
The server receives updated group configurations, generated labels, similarity values, and clustering parameters as input and stores them as history information in a recording medium.
The server analyzes patterns in the history, such as frequent corrections to certain clustering parameters or templates, and updates group classification conditions or prompt sentence generation conditions accordingly by adjusting thresholds, weights, or template selections. The server outputs revised configuration parameters that will be applied in subsequent executions of the feature extraction, similarity computation, clustering, and prompt generation processes, thus refining the system's behavior over time.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In large-scale software development, manufacturing control, and service operation environments, computer systems increasingly rely on natural-language interfaces and generative AI models to support users. However, conventional systems suffer from several technical problems.

First, when documents and communications contain inconsistent terminology, conventional text processing components treat synonymous or related expressions as independent tokens. This causes fragmentation of training data and metadata, degrades the quality of semantic representations, and leads to unstable or biased outputs from downstream components, including generative AI models and recommendation engines. As a result, the underlying computing system fails to maintain consistent data structures and cannot exploit term relationships efficiently.
Second, conventional systems typically generate prompt sentences for generative AI models in an ad-hoc, rule-based manner, without a normalized common language set that unifies domain terms across heterogeneous inputs. Without such a machine-readable common language set, the mapping from user input and historical data to prompts remains brittle. This results in higher token redundancy, ambiguous prompts, unnecessary context length, and an increased number of iterations between the application layer and the generative AI model. Consequently, computational resources such as processor time, memory capacity, and network bandwidth are inefficiently used.
Third, conventional systems handle user history and emotion signals, if at all, in a loosely coupled way. Emotion analysis results and user interest profiles are often stored separately from the term representations used for search, recommendation, or prompt generation. Therefore, the system cannot effectively adjust the internal language representations or the prompts fed to the generative AI model according to user-specific behavior and emotional state. This limits the ability of the computing system to adapt its internal models and causes suboptimal task execution, such as inappropriate recommendation ranking, unsuitable wording in feedback, or misaligned control instructions for external devices.
Fourth, existing architectures do not provide a unified mechanism to feed back usage logs and communication content from external applications, such as project management tools or information management devices, into the term clustering and prompt generation pipeline. As a result, the internal language resources of the system do not evolve in a structured, data-driven manner, and there is no closed loop that continuously refines the common language set and the prompt generation rules based on actual interaction data. This leads to degradation of model performance over time and requires costly manual maintenance. Accordingly, there is a need for an improved computer-implemented system that (i) automatically constructs and maintains a common language set by clustering semantically related terms, (ii) tightly integrates user history and emotion analysis into the weighting and selection of terms, (iii) programmatically generates optimized prompt sentences for a generative AI model based on the common language set, user interest, and emotion context, and (iv) feeds back response information and external communication content to update the common language set and prompt generation rules. Such a system should technically improve the way the processor manages language resources, reduces ambiguity in internal representations and prompts, and enhances computational efficiency and robustness of generative AI-based processing.

The specific processing by the specific processing unit 290 of the data processing device 12 in Application Example 2 is realized by the following means.

The present invention provides a server comprising a processor configured to extract, by using a natural language processing technique, a term set from design-related record information and business-related record information, and to generate term candidate information by performing morphological analysis processing, part-of-speech tagging processing, and importance calculation processing on the extracted term set; to calculate, based on the term candidate information, a semantic representation vector for each term candidate by using a semantic representation model, to group the term candidates according to semantic relatedness by statistical similarity calculation processing and clustering processing, to generate a common language set including, for each group, a standard term, a synonym expression, and definition information, and to register the common language set in a storage area; to acquire history information or work record information related to a user, to associate an item included in the history information or the work record information with the common language set, to calculate interest-degree information for each user, and to update weight information of each standard term in the common language set based on the interest-degree information; to execute emotion analysis processing on text information or text information derived from voice acquired from the user, to identify emotion type information and emotion intensity information, and to dynamically adjust, according to the emotion type information and the emotion intensity information, a selection criterion, expression content, and priority of terms in the common language set; to specify, based on the common language set, the interest-degree information, and the emotion type information, processing content, a target domain, and an output format to be executed by a generative AI model, and to automatically generate a prompt sentence describing the processing content, the target domain, and the output format by using the standard terms; to input the prompt sentence and contextual information into the generative AI model, to acquire response information from the generative AI model, and to generate recommendation information, control instruction information, or feedback information by performing term normalization processing and summarization processing on the response information in accordance with the common language set; and to output the recommendation information, the control instruction information, or the feedback information to a terminal device and to store, as additional learning data, selection operation information or confirmation operation information acquired from the terminal device as part of the history information. This enables the computing system to maintain a machine-readable common language layer that unifies heterogeneous inputs, to adapt internal term weights and prompt structures to user behavior and emotion in a closed-loop manner, to reduce ambiguity and redundancy in prompt sentences supplied to the generative AI model, and to improve overall processing efficiency, response relevance, and robustness of language-based interactions at the processor and memory architecture level.

The term “design-related record information” refers to information items recorded in a storage medium that describe planning, design, or specification aspects of a system, product, or process, including but not limited to text documents, structured records, and electronic files used as a basis for development or implementation.

The term “business-related record information” refers to information items recorded in a storage medium that describe operational, managerial, or communication aspects of a business process, including but not limited to messages, logs, reports, and transaction records used during execution or coordination of work.
The term “natural language processing technique” refers to a computer-implemented processing technique that analyzes, interprets, or transforms human language text by using algorithms such as tokenization, part-of-speech tagging, syntactic parsing, named entity recognition, or similar operations.
The term “term set” refers to a collection of lexical units, including words, phrases, and domain-specific expressions, that are extracted from one or more text sources and treated as discrete items for further computational analysis.
The term “term candidate information” refers to metadata associated with each term in a term set, including information such as morphological attributes, part-of-speech labels, occurrence frequencies, and computed importance scores that are used for subsequent selection or grouping.
The term “morphological analysis processing” refers to a sequence of computer-implemented operations that segment text into morphemes or tokens and assign morphological attributes, such as base forms or inflection types, to the segmented units.
The term “part-of-speech tagging processing” refers to a computer-implemented operation that assigns grammatical category labels, such as noun, verb, adjective, or adverb, to each token or term in a text sequence.
The term “importance calculation processing” refers to a computer-implemented operation that calculates a numerical value or rank for each term candidate based on criteria such as frequency, co-occurrence, position, or statistical weighting, so as to quantify the relative significance of the term within given data.
The term “semantic representation model” refers to a computational model that maps terms or text segments into numerical vector representations in a latent space such that semantic similarity between terms is reflected in distances or angles between the vectors.
The term “semantic representation vector” refers to a numerical vector output by a semantic representation model that encodes contextual or semantic properties of a term candidate in a multi-dimensional feature space.
The term “statistical similarity calculation processing” refers to a computer-implemented operation that calculates a quantitative measure of similarity between semantic representation vectors, such as cosine similarity or distance metrics, based on statistical properties of the vectors.
The term “clustering processing” refers to a computer-implemented operation that partitions a set of data points, including semantic representation vectors, into groups such that data points within the same group are more similar to each other than to data points in different groups.
The term “common language set” refers to a structured collection of language resources that define, for a plurality of groups of related terms, standardized lexical forms, synonym relations, and definition information, and that is used as a shared linguistic layer for normalization and processing of heterogeneous inputs.
The term “standard term” refers to a representative lexical form selected for a group of semantically related terms, which serves as a canonical label for that group within the common language set.
The term “synonym expression” refers to a lexical form, phrase, or variant that is semantically equivalent or closely related to a standard term and that is mapped to the standard term within the common language set.
The term “definition information” refers to descriptive data associated with a standard term, including explanations, usage constraints, or examples, which specify the intended meaning and scope of the standard term within the common language set.
The term “storage area” refers to a logical or physical memory region, such as a database or file system, in which the common language set and related metadata are stored so as to be accessible for later processing.
The term “history information” refers to recorded data describing past interactions between a user and one or more computing components, including access logs, selection records, command executions, and feedback inputs.
The term “work record information” refers to recorded data describing actions or operations performed in a work process, including task execution logs, status updates, and completion records that are associated with a user or a system.
The term “interest-degree information” refers to a set of numerical values or indicators that quantify a user's level of interest or engagement with particular terms, topics, or groups of content, derived from history information or work record information.
The term “weight information” refers to numerical parameters associated with standard terms in the common language set, which influence selection, ranking, or prioritization of the terms during subsequent processing.
The term “text information” refers to data expressed in a character-based representation, including sequences of symbols, words, or sentences, that can be processed by a natural language processing technique.
The term “text information derived from voice” refers to text information obtained by converting an audio signal, which includes speech from a user, into a character-based representation through speech recognition processing.
The term “emotion analysis processing” refers to a computer-implemented operation that analyzes text information to detect or estimate an emotion state, including polarity, type, or intensity, by applying linguistic or statistical models.
The term “emotion type information” refers to categorical data representing a classified emotion state, such as anger, fear, joy, sadness, fatigue, or other affective categories, determined by emotion analysis processing.
The term “emotion intensity information” refers to a numerical value or level representing the strength or magnitude of a detected emotion state associated with given text information. The term “selection criterion” refers to a rule, threshold, or scoring scheme used by the processor to decide whether to include, exclude, or emphasize particular terms or term groups in a given processing context.
The term “expression content” refers to the specific wording, phrasing, or lexical forms chosen to represent information in generated text, including the choice of standard terms and associated synonyms.
The term “priority of terms” refers to an ordering or ranking assigned to terms or term groups that determines their relative preference or prominence during selection, generation, or display.
The term “generative AI model” refers to an artificial intelligence model that, in response to an input sequence, produces generated output data such as text, control instructions, or structured information, by using learned parameters obtained from training on data.
The term “processing content” refers to a specification of an operation or task to be executed by the generative AI model, such as summarization, explanation, recommendation, or generation of control instructions.
The term “target domain” refers to a field or context to which the processing content of the generative AI model is directed, such as project management, manufacturing control, or customer interaction.
The term “output format” refers to a structural or stylistic specification for information generated by the generative AI model, including layout, level of detail, type of elements, or encoding.
The term “prompt sentence” refers to a text sequence that instructs a generative AI model to perform a specified processing content for a target domain in a given output format, and that is constructed using standard terms from the common language set.
The term “contextual information” refers to auxiliary data provided to the generative AI model together with a prompt sentence, including excerpts from documents, historical records, or metadata, which constrain or enrich the model's output.
The term “response information” refers to output data produced by the generative AI model in response to a prompt sentence and contextual information, including generated text, suggested actions, or proposed control instructions.
The term “term normalization processing” refers to a computer-implemented operation that transforms variant lexical forms in response information into corresponding standard terms defined in the common language set.
The term “summarization processing” refers to a computer-implemented operation that reduces the length or complexity of response information while preserving salient content, by selecting or generating shorter representations.
The term “recommendation information” refers to processed data that proposes one or more items, such as documents, actions, or content, to the user based on the common language set, interest-degree information, and emotion-related information.
The term “control instruction information” refers to processed data that specifies operations to be executed by an external device or system, such as start, stop, or parameter changes, and that is derived from response information.
The term “feedback information” refers to processed data that provides the user with explanations, status reports, or guidance generated based on the response information and normalized by the common language set.
The term “terminal device” refers to an input-output apparatus operated by a user, such as a personal computing device, mobile device, or wearable device, that exchanges data with the server and presents information to the user.
The term “selection operation information” refers to recorded data describing which item, option, or recommendation the user selected or confirmed in an interface presented by the terminal device.
The term “confirmation operation information” refers to recorded data describing explicit user acknowledgments, approvals, or rejections of information or instructions presented by the terminal device.
The term “additional learning data” refers to information derived from user operations, including selection operation information and confirmation operation information, that is stored and reused to update models, weights, or rules in subsequent processing.
The term “external application program” refers to a software component executing outside the server, such as a project management tool, communication tool, or workflow management tool, that interfaces with the server via a communication interface.
The term “external information management device” refers to a computing component or system that stores, organizes, or manages information outside the server, and that exchanges data with the server, including document repositories or database systems.
The term “term completion information” refers to suggestion data, generated based on the common language set, that proposes possible candidate terms or phrases while a user is entering text into an external application program or external information management device.
The term “communication content” refers to text or message data exchanged between users or between a user and a system through an external application program or an external information management device.
The term “generation rules of the prompt sentence” refers to a set of procedures, templates, and parameters used by the processor to construct prompt sentences, including selection of standard terms, insertion of context, and adaptation according to interest-degree information and emotion-related information.

In one embodiment, a server, a terminal, and a user cooperate to implement the claimed system. The server includes at least one processor, a main memory, a non-volatile storage device, and a network interface. The terminal includes an input apparatus such as a keyboard, a pointing device, a touch panel, or a microphone, and an output apparatus such as a display, a speaker, or a wearable display. The server and the terminal communicate via a communication network using a standardized communication protocol.

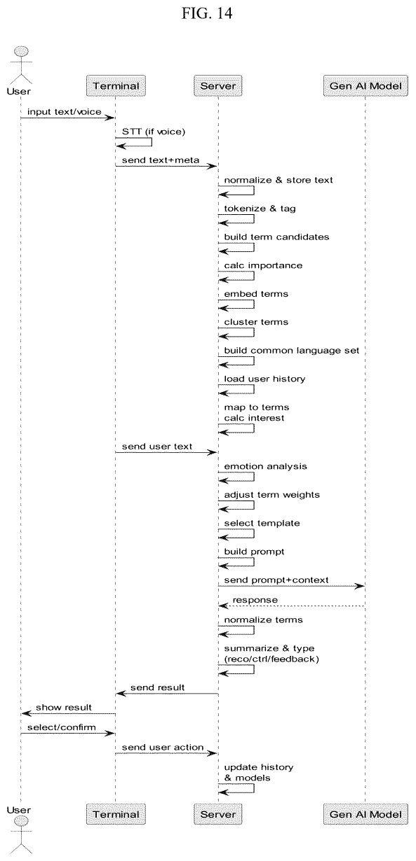

The server executes an operating system and an application program implementing the functions described below. The server uses a software stack that may include a scripting language runtime, a natural language processing library, a numerical computation library, and a machine learning library. For example, the server uses a Python runtime, a natural language processing library such as an open-source tokenization and tagging toolkit or a dependency parsing toolkit, a numerical library such as a matrix computation library, and a machine learning library such as a clustering toolkit or a neural network framework. The server stores design-related record information and business-related record information in a database management system, such as a relational database or a key-value store.
The server receives design-related record information and business-related record information from various data sources, such as version control repositories, project documentation repositories, communication logs, and manufacturing logs. The server normalizes each record to a consistent character encoding, stores the record as a text field, and associates metadata including a project identifier, a time stamp, and a source type with each record.
The server constructs a term set by performing morphological analysis processing and part-of-speech tagging processing on the normalized text. For example, the server uses a natural language processing library to segment text into tokens, assign a part-of-speech tag to each token, and merge adjacent tokens into candidate phrases based on syntactic patterns. The server further performs importance calculation processing by computing, for each candidate term, one or more term weights such as a term frequency-inverse document frequency score, a position-based weight, and a co-occurrence-based importance measure. The server stores the resulting term candidate information in the database as records including a term string, a base form, a part-of-speech tag, and at least one importance score.
The server calculates a semantic representation vector for each term candidate by using a semantic representation model. In one embodiment, the server uses a word embedding model such as a word vector model, a global co-occurrence embedding model, or a transformer-based contextual embedding model. The server either loads a pre-trained embedding model from the storage device or trains a domain-specific embedding model on the design-related record information and business-related record information. For training, the server uses a neural network architecture in which the input layer accepts token identifiers, an embedding layer maps each token to a dense vector, and one or more hidden layers (for example, fully connected layers or self-attention layers) learn parameters by minimizing a loss function such as a negative sampling loss or a masked language modeling loss. The server performs weight updates by using a gradient descent-based optimization algorithm such as stochastic gradient descent or adaptive moment estimation. During training, the server may perform data augmentation by shuffling contexts, dropping low-frequency tokens, or subsampling frequent tokens to improve generalization and reduce training time.
The server derives semantic representation vectors by applying the trained embedding model to each term candidate. When the semantic representation model is a transformer-based model, the server feeds a sequence of tokens into the model and extracts a specific layer output, such as the average of contextual token embeddings or the embedding corresponding to a classification token, as the semantic representation vector of the term. The server stores each semantic representation vector as a fixed-length numerical array in the database associated with the corresponding term candidate.
The server calculates statistical similarity between semantic representation vectors by computing a metric such as cosine similarity. The server performs clustering processing using a clustering algorithm such as k-means clustering, hierarchical clustering, or density-based spatial clustering. The server, for example, uses k-means clustering where the number of clusters k is determined based on an internal evaluation index such as a silhouette coefficient or an elbow method applied to the within-cluster variance. The server assigns each term candidate to a cluster whose centroid vector is closest to the term's semantic representation vector.
The server generates a common language set by, for each cluster, selecting a standard term and associating one or more synonym expressions and definition information with the standard term. The server may select the standard term based on a combination of importance scores and centrality within the cluster, such as choosing the term whose semantic representation vector is nearest to the cluster centroid and whose importance score exceeds a threshold. The server generates definition information by combining descriptive spans extracted from the design-related record information and business-related record information with template phrases. The server stores the common language set in the storage device as a structured data set containing, for each group, a standard term identifier, associated synonym identifiers, a definition text, and weight information.
The server acquires history information and work record information associated with a user from logging modules of the application program and from integrated external systems. History information includes, for example, identifiers of documents opened by the user, menu items selected, prompts submitted, and recommendations accepted. Work record information includes, for example, identifiers of tasks completed, machine operations triggered, and error resolutions recorded. The server maps each history or work item to one or more standard terms by matching metadata such as document tags or command identifiers to entries in the common language set. The server calculates interest-degree information by aggregating these mappings per user and per standard term, for example by computing exponentially decayed interaction counts, average dwell times, or normalized scores. The server updates weight information of each standard term in the common language set according to the interest-degree information, so that terms frequently associated with the user's activities receive higher weights. This adaptation changes subsequent ranking and selection of terms and directly affects how prompts and outputs are generated.
The terminal acquires user input in the form of text or voice. When the user speaks into a microphone, the terminal executes a speech recognition engine or calls a speech recognition service to convert the audio signal into text information. The terminal may detect the input language and apply an acoustic model and a language model appropriately. The terminal transmits the text information and associated context to the server via the network.
The server executes emotion analysis processing on the text information. In one embodiment, the server uses a neural network-based emotion classifier. The server represents the input text as a sequence of tokens and obtains an embedding sequence using the same or a related transformer-based model used for semantic representation. The server feeds the embedding sequence into a classification layer consisting of one or more fully connected layers and outputs a probability distribution over predefined emotion types such as anger, joy, sadness, fear, fatigue, and neutrality. The server calculates emotion type information as the emotion with maximum probability and emotion intensity information as, for example, the maximum probability value, an entropy-based confidence measure, or a continuous valence/arousal score derived from the logits. The classifier is trained in advance using labeled emotional text data, a cross-entropy loss function, and gradient-based optimization with regularization techniques such as dropout and weight decay.
The server dynamically adjusts the selection criterion, expression content, and priority of terms in the common language set in response to the emotion type information and the emotion intensity information. For example, when the server detects negative emotion such as anger or anxiety with high intensity, the server increases the priority of terms related to problem diagnosis, mitigation, or escalation, and reduces the use of technical jargon with low familiarity scores. When the server detects positive emotion such as satisfaction, the server emphasizes terms associated with successful outcomes. These adjustments are implemented by modifying term weights and by applying rule-based filters that consider both interest-degree information and emotion-related information. This dynamic adjustment changes which standard terms and synonyms are selected during generation and thereby alters the lexical and structural pattern of subsequent system outputs.
The server specifies processing content, a target domain, and an output format for a generative AI model based on the common language set, the interest-degree information, and the emotion type information. In one embodiment, the server maintains a set of prompt templates associated with specific target domains and processing content types, such as “summarization in project management,” “generation of machine control instructions,” or “recommendation of educational content.” Each template defines variable slots for standard terms, user context, and emotional context. The server fills these slots by selecting standard terms whose weight information and relevance to the current user input exceed predetermined thresholds. The server then constructs a prompt sentence as natural language text.
For example, when the user expresses concern about schedule delays, the server may generate a prompt sentence such as:
“Using the project's ubiquitous language set, analyze the current project progress and propose three concrete actions to improve the schedule, focusing on reducing the user's anxiety about delays.”
When the user requests terminology standardization, the server may generate a prompt sentence such as:
“From the following project documents and communications, extract all important agile project management terms and generate a consistent ubiquitous language set with clear definitions.”
When the user in a manufacturing context issues an informal instruction, the server may generate a prompt sentence such as:
“Analyze the following operator instruction and convert it into a precise machine command using the predefined ubiquitous language set.”
The server inputs the prompt sentence, together with contextual information such as document excerpts, logs, or machine states, into a generative AI model. In one embodiment, the generative AI model is a transformer-based sequence-to-sequence neural network. The model includes an encoder network and a decoder network, each composed of multiple self-attention layers and feed-forward layers. The encoder receives tokenized text of the prompt sentence and context, generates contextual embeddings, and passes them to the decoder. The decoder generates output tokens one by one while attending to encoder outputs and previously generated tokens. The generative AI model is trained prior to deployment on a large corpus of domain-general or domain-specific text by minimizing a sequence prediction loss function, such as a cross-entropy loss over the next token distribution. The model's parameters are updated by backpropagation and a gradient-based optimizer.
The server receives response information from the generative AI model as a token sequence. The server applies term normalization processing to map variant lexical forms in the response information to the standard terms defined in the common language set. For example, if the response contains both “UX” and “user experience,” the server replaces “UX” with the standard term “user experience” or annotates the synonym relationship explicitly. The server further performs summarization processing using either rule-based sentence selection or a neural abstractive summarizer to condense the response information into recommendation information, control instruction information, or feedback information tailored to the user's context and device capabilities.
The terminal displays or otherwise presents the recommendation information, control instruction information, or feedback information to the user. In a project management embodiment, the terminal may display a list of recommended documents, each labeled with standardized terms and short summaries. In a manufacturing embodiment, the terminal may display normalized control instruction information that can be confirmed by the user and transmitted to a machine controller. In a customer service embodiment, the terminal may present a short recommended response or an explanation to a human operator.
The server also outputs control instruction information to external devices or systems when such control is applicable. For example, in a manufacturing setting, the server converts normalized control instruction information into a machine-readable command format compliant with a fieldbus protocol or a device control API. The server transmits the command to a programmable logic controller or a robotic controller. By deriving such commands through the standardized common language set and controlled prompt generation, the system reduces the risk of misinterpretation and inconsistent device behavior, thereby providing a direct technical effect on machine operation.
The server stores selection operation information and confirmation operation information from the terminal as additional learning data. The server periodically uses this additional learning data to retrain or fine-tune components such as the semantic representation model, the emotion classifier, and the term weighting module. For example, the server evaluates whether recommendations generated based on certain term clusters are frequently accepted or rejected, and adjusts cluster boundaries or term weights accordingly. The server may also update prompt generation rules by learning from successful and unsuccessful generative AI outputs, for instance by adjusting template structures, adding constraint phrases, or modifying default output formats to reduce unnecessary verbosity and to improve answer relevance. This closed-loop adaptation allows the system to refine internal models and structures in a way that would be impractical for a human operator to manage manually across the scale and speed of interactions handled by the server.
In an alternative embodiment, the server interfaces with external application programs or external information management devices, such as project management tools, communication platforms, or document management systems. The server provides the common language set to these external components via an application programming interface. The external components query the server for term completion information and definition information when a user inputs text, and the server responds with standardized term suggestions and corresponding definitions. The server also acquires communication content from the external components, executes natural language processing and emotion analysis processing on the acquired content, and updates the common language set and the generation rules of the prompt sentence. This integration leads to a unified language layer across multiple software components and reduces redundancy and inconsistency in term management at the system level.
From a technical standpoint, the system improves computer technology in several ways. By mapping diverse lexical inputs to a common language set using learned semantic representation vectors and clustering, the server reduces fragmentation of the term space and compresses heterogeneous input into a structured, machine-readable layer. This compression improves caching behavior, reduces the amount of redundant data stored and transmitted, and stabilizes downstream computations such as similarity search and prompt construction. By using dynamically updated interest-degree information and emotion-driven term weighting, the server alters the internal selection of features supplied to the generative AI model. This leads to more focused prompts with fewer irrelevant tokens, thereby reducing the model's inference time, memory usage, and sensitivity to noise.
Moreover, the system does not merely automate human drafting of messages. The server executes non-conventional processing sequences, including joint use of semantic clustering, emotion-dependent reweighting, and template-based prompt assembly, which are specifically tailored to the structure and constraints of neural sequence models. The server applies optimization steps such as selecting cluster centroids as canonical labels and tuning the number of clusters based on internal metrics, which are not typical in manual human workflows. As a result, the system achieves a measurable reduction in ambiguous prompts, a reduction in the number of iterative interactions required to obtain an acceptable generative AI output, and an improvement in correctness of control instruction translation for external devices.
Because the server maintains and updates the common language set and associated generation rules based on cumulative usage logs, the system also improves long-term data management. Instead of storing only raw unstructured logs, the server maintains structured term clusters, term weights, and rule parameters that can be efficiently queried and updated. This structured representation supports faster retrieval, more accurate indexing, and simplified consistency maintenance across large data volumes.
In another embodiment, the generative AI model may be replaced by a smaller domain-specific model trained only on the domain's common language set and related corpora. In this configuration, the server uses transfer learning, where the base neural network weights are initialized from a generic model and then fine-tuned using domain-specific examples. The server adjusts learning rates and employs early stopping based on validation loss to prevent overfitting. This configuration reduces the model size and computation cost while preserving domain performance, and it leverages the structured common language set to guide training.
In yet another embodiment, the emotion analysis processing may employ a multi-task learning network that jointly predicts emotion type, emotion intensity, and user engagement level. The shared encoder reduces computation, and multi-task loss weighting allows the server to balance accuracy across tasks. Because the server feeds these multiple outputs into the term weighting and prompt assembly modules, the system can more precisely control the style and emphasis of generated outputs, further improving the technical robustness of language-based interactions.
Through these embodiments, the server, the terminal, and the user collectively implement a system in which the internal data structures, algorithms, and neural models are arranged to improve processing efficiency, accuracy of term normalization, stability of generative outputs, and safety of device control, thereby providing technical effects that go beyond a mere automation of human mental processes or business methods.
The following describes the processing flow using FIG. 14.

### Step 1:

User provides source information
User inputs source information through the terminal. The input includes design-related record information, business-related record information, or free-form comments, entered as text via a keyboard or as voice via a microphone. The terminal converts voice to text by executing or invoking a speech recognition engine and attaches metadata such as a user identifier, a project identifier, a time stamp, and a source type. The terminal sends the resulting text and metadata to the server over a network.
Input: Raw user input (text or audio) and associated metadata.
Output: Text information with metadata transmitted from the terminal to the server.

### Step 2:

Server normalizes and stores text
Server receives the text information and metadata from the terminal via a communication interface. Server converts the text to a standard character encoding, removes control characters, and normalizes whitespace. Server writes the normalized text and metadata into a database table, creating one record per source item and assigning a unique record identifier. Input: Text information with metadata received from the terminal.
Output: Normalized text records stored in a database with record identifiers.

### Step 3:

Server performs tokenization and linguistic annotation
Server reads normalized text records from the database and applies a natural language processing toolkit to perform tokenization and part-of-speech tagging. Server segments each text into a sequence of tokens, assigns a grammatical category tag to each token, and detects phrase boundaries based on syntactic patterns. Server generates term candidates by grouping tokens into words and phrases that satisfy predefined patterns, such as noun phrases or verb-object combinations.
Input: Normalized text records retrieved from storage.
Output: Annotated token sequences and term candidate lists associated with each record.

### Step 4:

Server calculates importance scores for term candidates
Server processes each term candidate list to compute importance scores. Server calculates, for each term candidate, a term frequency within the corpus, an inverse document frequency, and optionally a position-based or co-occurrence-based weight. Server combines these metrics into a single importance score using a weighted formula. Server stores, for each term candidate, a data record containing the term string, base form, part-of-speech, and calculated importance score.
Input: Term candidate lists with linguistic annotations.
Output: Term candidate information records with numerical importance scores.

### Step 5:

Server generates semantic representation vectors
Server loads or initializes a semantic representation model, such as a word embedding or contextual embedding model. Server converts each term candidate into a token index sequence and feeds the sequence into the semantic representation model. Server obtains a fixed-dimensional vector for each term candidate by extracting the appropriate layer output (for example, a token embedding or an averaged contextual embedding). Server stores the semantic representation vector as an array of numerical values linked to the corresponding term candidate information.
Input: Term candidate information records and a semantic representation model.
Output: Semantic representation vectors associated with term candidates.

### Step 6:

Server groups term candidates into clusters Server loads semantic representation vectors from storage and computes pairwise similarity values, such as cosine similarity, between vectors. Server applies a clustering algorithm, for example k-means, to partition the vectors into clusters according to similarity. Server assigns each term candidate an integer cluster identifier corresponding to the nearest cluster centroid. Server writes the cluster assignment and centroid information back to the database.
Input: Semantic representation vectors for term candidates.
Output: Cluster assignments and cluster centroid vectors for all term candidates.

### Step 7:

Server constructs a common language set
Server creates, for each cluster, an entry of a common language set. Server selects a standard term for the cluster by choosing the term candidate whose vector is closest to the cluster centroid and whose importance score exceeds a threshold. Server designates other terms in the same cluster as synonym expressions. Server builds definition information by extracting representative sentences or phrases from the original text records containing the standard term and simplifying them using template-based rules. Server stores each common language set entry with a standard term, a list of synonyms, definition text, and initial weight information.
Input: Cluster assignments, term candidate information, and original text records.
Output: Common language set entries with standard terms, synonyms, definitions, and weights.

### Step 8:

Server maps user history and work records to common language terms
Server retrieves history information and work record information linked to each user from log tables. For each history or work record, server inspects associated metadata such as document identifiers, tags, and command identifiers and maps them to standard terms in the common language set using lookup tables and string matching. Server counts the number and recency of occurrences of each standard term per user and computes interest-degree information as a normalized score, for example using an exponentially decayed sum. Server updates the weight information of standard terms by combining base weights with user-specific interest scores.
Input: History information, work record information, and common language set entries.
Output: Updated weights for standard terms and user-specific interest-degree information.

### Step 9:

Server analyzes user emotion from text input
Server receives current user text input from the terminal, either as direct text or as text derived from speech. Server encodes the text into token sequences and feeds them into an emotion classification model implemented as a neural network. Server obtains a probability distribution over predefined emotion types and calculates an emotion type label as the most probable type and an emotion intensity value as a function of the probability distribution. Server associates the emotion type information and emotion intensity information with the current interaction context and stores them in a session record.
Input: Current user text input.
Output: Emotion type information and emotion intensity information linked to the current context.

### Step 10:

Server adjusts term selection and priority using interest and emotion
Server accesses the common language set and retrieves standard terms relevant to the current context based on matching with the user input, the user's interest-degree information, and the detected emotion type. Server modifies the weights of these standard terms by applying rules that amplify or attenuate weights depending on emotion type and intensity; for example, server increases weights for diagnostic or supportive terms when negative emotion is strong. Server computes a new priority order of terms for use in subsequent generation and selection processes and stores the adjusted priorities in memory for the current session.
Input: Common language set entries, interest-degree information, and emotion information.
Output: Adjusted term weights and priority lists for the current interaction.

### Step 11:

Server selects a processing template and target domain
Server determines the processing content and target domain based on the user's request, the type of source information, and the application configuration. For example, server selects a “summarization” template for long documents, a “control command generation” template for operator instructions, or a “recommendation” template for content queries. Server retrieves the corresponding template structure, which defines variable slots for standard terms, user context, and emotional qualifiers.
Input: User request context, common language set, and template definition data.
Output: Selected template structure and associated slot definitions for prompt construction.

### Step 12:

Server generates a prompt sentence for the generative AI model
Server fills the slots of the selected template with standard terms ranked highly in the adjusted priority list, relevant contextual snippets from design-related and business-related records, and phrases reflecting the detected emotion when appropriate. Server arranges these elements into a natural-language prompt sentence according to template rules regarding order, connective words, and output format specification. Server produces a final prompt sentence string that explicitly describes the requested processing content, target domain, and desired output format using standardized terminology.
Input: Template structure, adjusted term priorities, context snippets, and emotion information.
Output: Prompt sentence text ready to be input to the generative AI model.

### Step 13:

Server invokes the generative AI model with prompt and context
Server tokenizes the prompt sentence and relevant context documents and constructs an input sequence for the generative AI model. Server sends this input sequence to the model runtime, which may execute on the same hardware or on a dedicated inference environment. Server specifies decoding parameters, such as maximum output length and sampling strategy, and initiates inference. Server receives a sequence of output tokens from the generative AI model that constitutes the model's response information.
Input: Tokenized prompt sentence and contextual information.
Output: Response information generated by the generative AI model as a token sequence.

### Step 14:

Server normalizes terms in the model response
Server converts the response token sequence back into text and splits the response into lexical units. Server compares each lexical unit to entries in the common language set, using exact matching and approximate matching algorithms, and replaces or annotates non-standard expressions with corresponding standard terms. Server records mappings from original expressions to standard terms to maintain traceability. The result is a normalized response text in which terminology is aligned with the common language set.
Input: Response information from the generative AI model and the common language set.
Output: Normalized response text where variants are mapped to standard terms.

### Step 15:

Server summarizes and classifies the normalized response Server analyzes the normalized response text to determine whether it should be treated as recommendation information, control instruction information, or feedback information based on structural patterns and template tags. Server applies summarization processing, such as scoring and selecting key sentences or generating condensed text with a summarization model, to produce an output of appropriate length and detail for the target device and user role. Server structures the summarized output into a data object containing a type label, a short title, and a body text.
Input: Normalized response text and classification rules.
Output: Structured output object categorized as recommendation, control instruction, or feedback information.

### Step 16:

Server sends output to the terminal and records user operations
Server transmits the structured output object to the terminal over the network. Server logs an event indicating that specific recommendation, control instruction, or feedback information has been presented to the user. After presentation, server receives from the terminal information about user operations, such as which recommendation item was selected, whether a control instruction was confirmed, or whether feedback was accepted or ignored. Server writes these user operation records as additional entries in history information and work record information tables.
Input: Structured output object and user operation data from the terminal.
Output: Presented information on the terminal and updated history and work records in the server.

### Step 17:

Terminal presents information to the user Terminal receives the structured output object from the server and interprets its type label. Terminal selects an appropriate presentation method, such as a list view for recommendation information, a confirmation dialog for control instruction information, or a message panel for feedback information. Terminal renders the standardized terms, definitions, and summarized text on the display or outputs them via audio if necessary. Terminal records the user's selection or confirmation actions and prepares corresponding operation data for transmission back to the server.
Input: Structured output object from the server.
Output: Visual or auditory presentation to the user and operation data representing user actions.

### Step 18:

Server updates models and language resources using additional learning data Server periodically aggregates selection operation information and confirmation operation information stored as history information. Server analyzes patterns such as acceptance rates for recommendations associated with specific term clusters, success or failure of control instructions, and user satisfaction signals inferred from emotion trends after interactions. Server uses these statistics to adjust term weights in the common language set, to refine clustering parameters, and to update prompt generation rules. When sufficient data is accumulated, server fine-tunes neural models, such as the semantic representation model or emotion classifier, using the additional learning data as training examples, updating model parameters to reduce prediction error.
Input: Accumulated history information, work record information, and additional learning data.
Output: Updated common language set, adjusted prompt generation rules, and fine-tuned model parameters.
The data generation model 58 is a so-called generative artificial intelligence (AI). Examples of the data generation model 58 include generative Als such as ChatGPT (registered trademark) (Internet search<URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

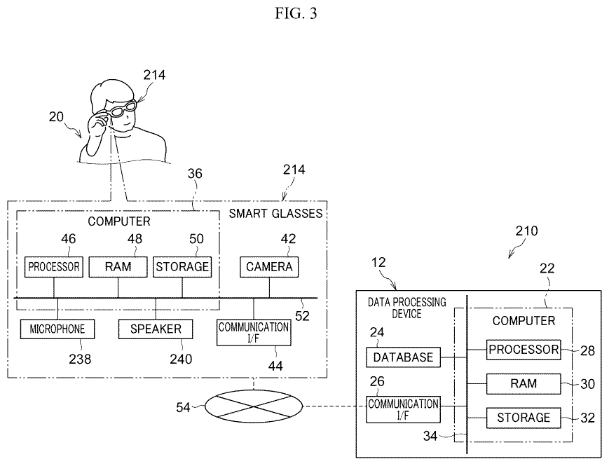

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

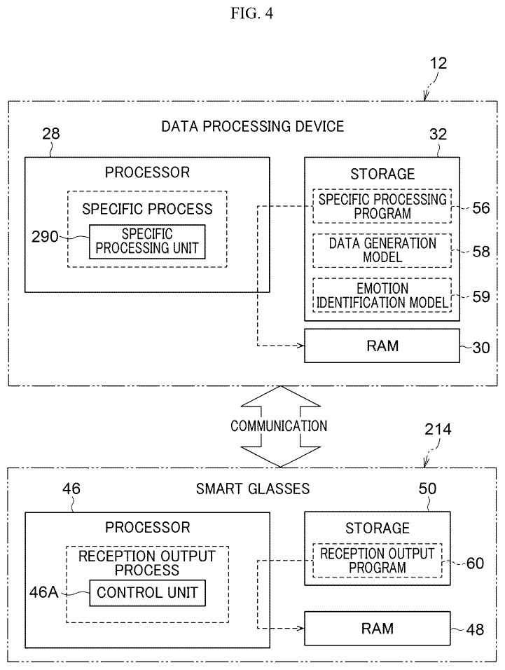

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search<URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

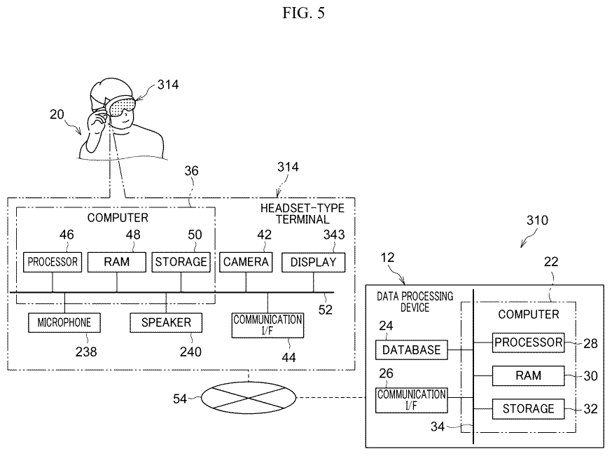

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

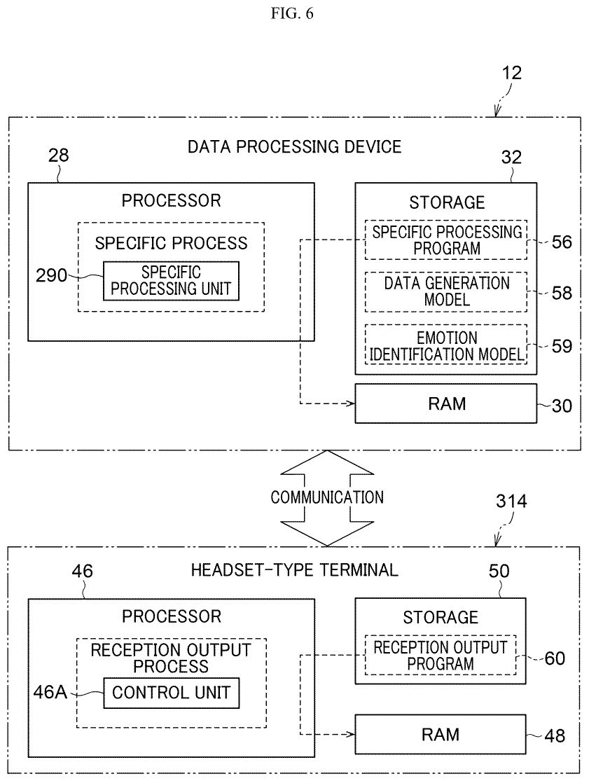

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search<URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

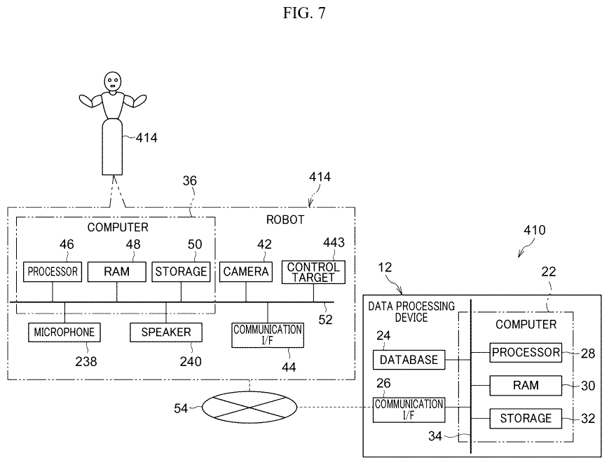

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

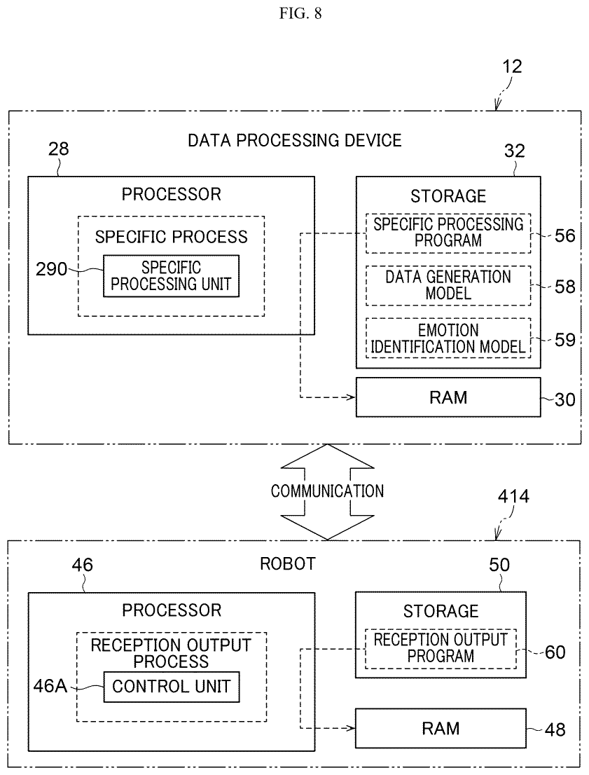

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search<URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

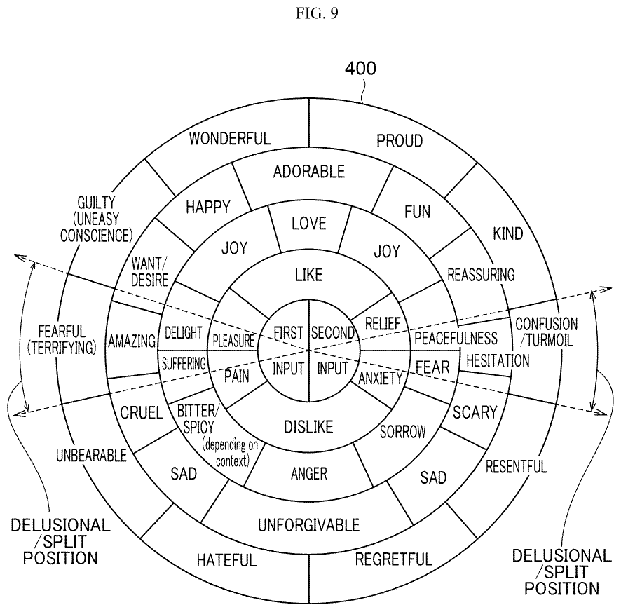

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

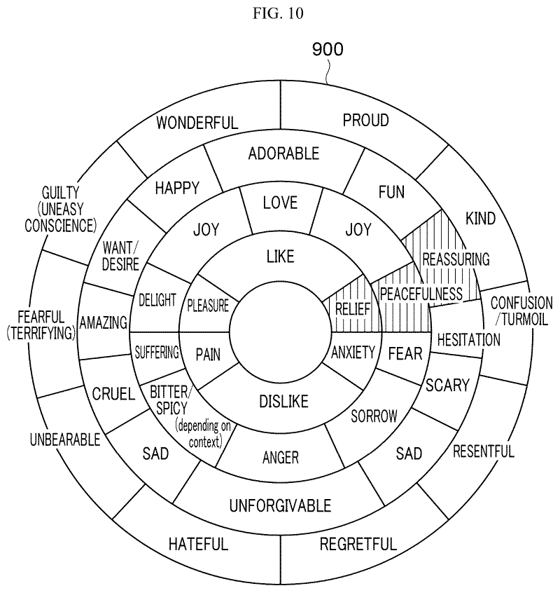

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief’,” peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive document data and communication data related to planning, designing, or business operations from an information processing terminal of a user,
extract character information from the received document data and communication data and perform normalization processing and tokenization processing on the character information by using a natural language processing technique,
apply a machine learning technique including a statistical analysis method to the tokenized character information to calculate an importance index and extract words or word sequences that are determined to be important in a project,
analyze semantic relationships of the extracted words or word sequences, integrate synonymous or similar words to determine standard terms, and construct a common language set including the standard terms, definitions of the standard terms, and related words, store the common language set in a storage unit and manage the common language set as a lexical resource that is referable for each project,
generate, on the basis of the common language set and background information of the project obtained from the document data or the communication data, a prompt sentence in accordance with a template so as to cause a generative AI model to execute predetermined processing,
output the generated prompt sentence in a format that allows the user to view and edit the generated prompt sentence on a display device, and transmit an edited prompt sentence to the generative AI model, and
receive response information from the generative AI model and, while evaluating consistency of terminology in the response information based on the common language set, present the response information to the information processing terminal of the user.

### (Supplementary 2)

The system according to supplementary 1,
wherein the processor is configured to
perform natural language processing including emotion analysis on character input or voice input of the user, and adjust selection of the standard terms or contents of definitions included in the common language set based on a result of the emotion analysis.

### (Supplementary 3)

The system according to supplementary 1,
wherein the processor is configured to
input the generated prompt sentence or the prompt sentence edited by the user to the generative AI model, acquire response information or proposal information from the generative AI model, and output the response information or the proposal information as success factors, issues, or risks in the project by referring to the common language set.

### Application Example 1

### (Supplementary 1)

A system comprising a processor,
wherein the processor is configured to
acquire character information from a group of documents including information related to planning and design and information related to operations, and extract words or phrases from the character information by using a natural language processing technique, and
analyze part-of-speech information, occurrence frequency, and dependency relationships for the extracted words or phrases, determine importance based on semantic relevance, and generate a common vocabulary set having consistency across the group of documents, and extract, as structured data, important information representing target elements, work contents, and constraint conditions from a group of documents including information related to work instructions and information related to work reports, based on the common vocabulary set and the group of documents, and
perform arithmetic processing to optimize a work sequence and a resource allocation based on the structured data, and generate optimized work procedure data for machine equipment or a processing apparatus, and
generate a prompt sentence for instructing a generative artificial intelligence model to execute vocabulary extraction or information extraction processing, based on the common vocabulary set and the structured data, and
input the prompt sentence and the group of documents into the generative artificial intelligence model, acquire words or important information output from the generative artificial intelligence model, and integrate the acquired words or important information with extraction results obtained by the natural language processing technique to update the common vocabulary set and the structured data, and
transmit the optimized work procedure data to the machine equipment and output the optimized work procedure data as control information for improving an operation efficiency of the machine equipment.

### (Supplementary 2)

The system according to supplementary 1,
wherein the processor is configured to
cause an information terminal to display the optimized work procedure data, the common vocabulary set, and the prompt sentence based on input from a user via the information terminal, receive a correction instruction or evaluation information from the user, and update at least one of the common vocabulary set, the prompt sentence, and an optimization condition of the work sequence based on the correction instruction or the evaluation information.

### (Supplementary 3)

The system according to supplementary 1,
wherein the processor is configured to
analyze input information including an emotion from a user, estimate an emotional state of the user, and adjust a content of at least one of the common vocabulary set and the prompt sentence in accordance with the emotional state.

### Example 2

### (Supplementary 1)

A system comprising a processor,
wherein the processor is configured to
extract linguistic expressions from information records and dialogue records,
analyze semantic relatedness of the extracted linguistic expressions as numerical data by using language processing resources and lexical resources, and classify the linguistic expressions into a plurality of groups based on the numerical data to generate common term groups,
generate feature vectors for the common term groups by using a semantic representation model, and calculate similarity on the basis of the feature vectors to update compositions of the common term groups,
generate, for each of the common term groups, a prompt sentence to be presented to a generative information processing model, input the prompt sentence into the generative information processing model to obtain an abstract group name or a descriptive text representing the common term group, and associate the group name or the descriptive text with the common term group to construct a common language set,
generate an additional prompt sentence for specifying an information processing task on the basis of the common term groups and the group names included in the common language set, and input the additional prompt sentence into the generative information processing model, and
transmit the common language set to a terminal device and cause the terminal device to display the common term groups.

### (Supplementary 2)

The system according to supplementary 1,
wherein the processor is configured to
receive linguistic expressions transmitted from an input unit operated by a user, transmit the linguistic expressions to the processor, output the common language set received from the processor as display information, and, based on confirmation and correction operations performed by the user, retransmit updated common term groups so as to iteratively update a configuration of the common language set.

### (Supplementary 3)

The system according to supplementary 1,
wherein the processor is configured to
store, in a recording medium, history information including the feature vectors, similarity data, group classification results, and response data obtained from the generative information processing model that are used in generation of the common language set, and automatically adjust subsequent group classification conditions or prompt sentence generation conditions based on the history information.

### Application Example 2

### (Supplementary 1)

A system comprising a processor,
wherein the processor is configured to
extract a term set from design-related record information and business-related record information by using a natural language processing technique, and generate term candidate information by performing morphological analysis processing, part-of-speech tagging processing, and importance calculation processing on the extracted term set; and
calculate a semantic representation vector for each term candidate by using a semantic representation model based on the term candidate information, group the term candidates according to semantic relatedness by statistical similarity calculation processing and clustering processing, generate a common language set including, for each group, a standard term, a synonym expression, and definition information, and register the common language set in a storage area; and
acquire history information or work record information related to a user, associate an item included in the history information or the work record information with the common language set, calculate interest-degree information for each user, and update weight information of each standard term in the common language set based on the interest-degree information; and
execute emotion analysis processing on text information or text information derived from voice acquired from the user, identify emotion type information and emotion intensity information, and dynamically adjust, according to the emotion type information and the emotion intensity information, a selection criterion, expression content, and priority of terms in the common language set; and
specify, based on the common language set, the interest-degree information, and the emotion type information, processing content, a target domain, and an output format to be executed by a generative AI model, and automatically generate a prompt sentence describing the processing content, the target domain, and the output format by using the standard terms; and
input the prompt sentence and contextual information into the generative AI model, acquire response information from the generative AI model, and generate recommendation information, control instruction information, or feedback information by performing term normalization processing and summarization processing on the response information in accordance with the common language set; and
output the recommendation information, the control instruction information, or the feedback information to a terminal device, and store, as additional learning data, selection operation information or confirmation operation information acquired from the terminal device as part of the history information.

### (Supplementary 2)

The system according to supplementary 1,
wherein the processor is configured to
receive, from a terminal device, text information converted from voice input of the user by speech recognition processing, and send the recommendation information, the control instruction information, or the feedback information to the terminal device so that the terminal device presents the recommendation information, the control instruction information, or the feedback information to the user and transmits additional input information and selection result information from the user to the processor.

### (Supplementary 3)

The system according to supplementary 1,
wherein the processor is configured to
provide the common language set to an external application program or an external information management device, cause the external application program or the external information management device to automatically present term completion information and definition information based on the common language set when a term is input, acquire communication content from the external application program or the external information management device, analyze the communication content by the natural language processing technique and the emotion analysis processing, and update the common language set and generation rules of the prompt sentence based on an analysis result.

What is claimed is:

1. A system comprising:
circuitry configured to:
receive, from a terminal device via a packet-switched network, document data and communication data;
extract character information from the received document data and communication data, and perform normalization processing and tokenization processing on the character information by using a natural language processing technique;
apply a statistical analysis method to the tokenized character information to calculate an importance index, and extract terms or term sequences determined to exceed an importance threshold;
analyze semantic relationships of the extracted terms or term sequences by computing similarity measures based on semantic embeddings, integrate synonymous or similar terms to determine standard terms, and construct a common language dataset including the standard terms, definitions of the standard terms, and related terms;
store the common language dataset in a storage device and manage the common language dataset as a lexical resource;
generate, based on the common language dataset and context information derived from the document data or the communication data, a prompt sentence in accordance with a template so as to cause a generative neural network model to execute predetermined processing; and
transmit the prompt sentence to the generative neural network model via the packet-switched network, receive response data from the generative neural network model, evaluate terminology consistency of the response data based on the common language dataset, and transmit the response data to the terminal device.

2. The system according to claim 1, wherein the circuitry is configured to output the generated prompt sentence to the terminal device in a format that allows a user to view and edit the prompt sentence on a display, and upon receiving an edited prompt sentence from the terminal device via the packet-switched network, transmit the edited prompt sentence to the generative neural network model.

3. The system according to claim 2, wherein the circuitry is configured to receive, from the terminal device, a correction instruction or evaluation information regarding the response data, and update at least one of the common language dataset, the prompt sentence, or a processing condition based on the correction instruction or the evaluation information.

4. The system according to claim 3, wherein the circuitry is configured to analyze part-of-speech information, occurrence frequency, and dependency relationships for the extracted terms or term sequences, and determine the importance index based on a combination of semantic relevance and statistical frequency.

5. The system according to claim 4, wherein the circuitry is configured to generate feature vectors for the extracted terms using a semantic representation model comprising an embedding layer, compute cosine similarity between the feature vectors, and group terms having a similarity exceeding a predetermined threshold into a common term group.

6. The system according to claim 5, wherein the circuitry is configured to generate a prompt sentence for each common term group, input the prompt sentence to the generative neural network model to obtain a group name or descriptive text representing the common term group, and associate the group name or descriptive text with the common term group to construct the common language dataset.

7. The system according to claim 1, wherein the generative neural network model comprises a transformer architecture including an embedding layer, a plurality of self-attention layers, and an output layer producing a probability distribution over a token vocabulary.

8. The system according to claim 7, wherein the circuitry is configured to set inference parameters for the generative neural network model including a temperature value, a sampling threshold, and a maximum output token count so as to control determinism and length of the response data.

9. The system according to claim 8, wherein the circuitry is configured to apply constrained decoding in which generated tokens are validated against the common language dataset to ensure that the response data uses standard terms.

10. The system according to claim 9, wherein the circuitry is configured to store history information including the feature vectors, similarity data, group classification results, and response data in the storage device, and automatically adjust subsequent group classification conditions based on the stored history information.

11. The system according to claim 1, wherein the circuitry is configured to extract structured data representing target elements, operational contents, and constraint conditions from the document data based on the common language dataset, and perform arithmetic processing to optimize a sequence and a resource allocation based on the structured data.

12. The system according to claim 11, wherein the circuitry is configured to generate optimized procedure data based on the arithmetic processing, and transmit the optimized procedure data to an apparatus via the packet-switched network as control information.

13. The system according to claim 12, wherein the circuitry is configured to input the common language dataset and the structured data to the generative neural network model with a prompt sentence instructing extraction of additional terms or information, and integrate terms output by the generative neural network model with extraction results obtained by the natural language processing technique to update the common language dataset.

14. The system according to claim 1, wherein the circuitry is configured to perform natural language processing including emotion analysis on at least one of character input or voice input received from the terminal device, estimate an emotional state of a user, and adjust selection of the standard terms or contents of definitions included in the common language dataset based on the estimated emotional state.

15. The system according to claim 14, wherein the circuitry is configured to modify a style or tone of the prompt sentence according to the estimated emotional state so as to cause the generative neural network model to generate response data adapted to the emotional state.

16. The system according to claim 1, wherein the circuitry is configured to acquire response data or proposal data from the generative neural network model and map the response data or proposal data to categories including success factors, issues, or risks by referring to the common language dataset.

17. The system according to claim 16, wherein the circuitry is configured to transmit the mapped categories and associated response data to the terminal device via the packet-switched network and cause the terminal device to display the categories as selectable elements for iterative refinement.

18. A system comprising:
circuitry configured to:
receive, from a terminal device via a packet-switched network, document data and communication data, and extract character information from the document data and communication data by performing normalization and tokenization;
calculate an importance index for extracted terms by applying a statistical analysis method including term-frequency inverse-document-frequency computation, and extract terms exceeding an importance threshold;
analyze semantic relationships of the extracted terms by generating semantic embedding vectors using a neural network model, computing similarity between the vectors, grouping semantically similar terms, and selecting standard terms for each group to construct a common language dataset;
store the common language dataset in a storage device;
generate a prompt sentence based on the common language dataset and context information derived from the document data, the prompt sentence conforming to a template that specifies a task for a generative neural network model comprising a transformer architecture with self-attention layers;
transmit the prompt sentence to the generative neural network model, receive response data, and evaluate terminology consistency of the response data against the common language dataset; and
transmit the response data and terminology evaluation results to the terminal device via the packet-switched network.

19. The system according to claim 18, wherein the circuitry is configured to perform emotion analysis on input data received from the terminal device, estimate an emotional state of a user, and adjust at least one of the standard terms in the common language dataset or a style of the prompt sentence according to the estimated emotional state.

20. A method comprising:
receiving, by circuitry from a terminal device via a packet-switched network, document data and communication data;
extracting character information from the received document data and communication data, and performing normalization processing and tokenization processing on the character information by using a natural language processing technique;
applying a statistical analysis method to the tokenized character information to calculate an importance index, and extracting terms or term sequences determined to exceed an importance threshold;
analyzing semantic relationships of the extracted terms or term sequences by computing similarity measures based on semantic embeddings, integrating synonymous or similar terms to determine standard terms, and constructing a common language dataset including the standard terms, definitions of the standard terms, and related terms;
storing the common language dataset in a storage device;
generating, based on the common language dataset and context information derived from the document data or the communication data, a prompt sentence in accordance with a template so as to cause a generative neural network model to execute predetermined processing; and
transmitting the prompt sentence to the generative neural network model via the packet-switched network, receiving response data from the generative neural network model, evaluating terminology consistency of the response data based on the common language dataset, and transmitting the response data to the terminal device.
